(19) United States
(12) Patent Application Publication
(10) Pub. No.: US 2025/0246611 A1
(43) Pub. Date: Jul. 31, 2025

(54) ELECTRODE, NEGATIVE ELECTRODE ACTIVE MATERIAL, NEGATIVE ELECTRODE, SECONDARY BATTERY, MOVING VEHICLE, ELECTRONIC DEVICE, METHOD FOR FABRICATING NEGATIVE ELECTRODE ACTIVE MATERIAL, AND METHOD FOR FABRICATING NEGATIVE ELECTRODE

(71) Applicant: Semiconductor Energy Laboratory Co., Ltd., Atsugi-shi (JP)

(72) Inventors: Kazutaka KURIKI, Ebina (JP); Taisuke NAKAO, Atsugi (JP); Yoshiharu ASADA, Odawara (JP); Yumiko YONEDA, Isehara (JP)

(21) Appl. No.: 19/182,875

(22) Filed: Apr. 18, 2025

Related U.S. Application Data
(63) Continuation of application No. 18/017,189, filed on Jan. 20, 2023.

(30) Foreign Application Priority Data
Aug. 7, 2020 (JP) 2020-135119

(51) Int. Cl. H01M 4/36; H01M 4/02; H01M 4/04; H01M 4/38; H01M 4/583; H01M 4/62; H01M 10/0525

(52) U.S. Cl. CPC H01M 4/366; H01M 4/0471; H01M 4/386; H01M 4/583; H01M 4/625; H01M 10/0525; H01M 2004/021; H01M 2004/027; H01M 2220/20

(57) ABSTRACT

A negative electrode with little deterioration is provided. A novel negative electrode is provided. A power storage device with little deterioration is provided. A novel power storage device is provided. The electrode contains silicon, graphite, and a graphene compound. A silicon particle with a particle diameter of less than or equal to 1 μm is attached to a graphite particle with a particle diameter 10 times or more that of the silicon particle. The graphene compound is in contact with the graphite particle so as to cover the silicon particle.

### TECHNICAL FIELD

One embodiment of the present invention relates to an electrode and a method for fabricating the electrode. Another embodiment of the present invention relates to an active material included in an electrode and a method for fabricating the active material. Another embodiment of the present invention relates to a secondary battery and a method for fabricating the secondary battery. Another embodiment of the present invention relates to a moving vehicle such as a vehicle, a portable information terminal, an electronic device, and the like each including a secondary battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof. Note that an electronic device in this specification refers to every device including a power storage device; an electro-optical device including a power storage device, an information terminal device including a power storage device, and the like are all electronic devices.

Note that a power storage device in this specification refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

### REFERENCES

### Patent Documents

### Patent Document 1

Japanese Published Patent Application No. 2002-216751

### Patent Document 2

Japanese Published Patent Application No. 2019-522886

### SUMMARY OF THE INVENTION

### Problems to be Solved by the Invention

Capacity of secondary batteries used in moving vehicles such as electric vehicles or hybrid vehicles need to be increased for longer driving ranges.

Furthermore, portable terminals and the like have more and more functions, resulting in an increase in power consumption. In addition, reductions in size and weight of secondary batteries used for portable terminals and the like are demanded. Therefore, secondary batteries used for portable terminals are also desired to have higher capacity.

It is important for secondary batteries to have high capacity as well as stability. An alloy-based material such as a silicon-based material has high capacity and thus is promising as an active material of a secondary battery. However, an alloy-based material with high charge and discharge capacity causes problems such as pulverization and detachment of an active material due to a volume change in charging and discharging, and thus has not achieved sufficient cycle performance.

In order to solve the above problems of an alloy-based material, a combination of an alloy-based material and graphite or a carbonaceous material has been considered. Patent Document 1 describes a composite material in which a covering layer formed of carbon is formed on a surface of a porous particle nucleus in which a silicon-containing particle and a carbon-containing particle are bonded to each other. Patent Document 2 describes a composite particle containing silicon (Si), lithium fluoride (LiF), and a carbon material. However, neither of the above documents has solved the problems such as pulverization and detachment of an active material due to expansion of an alloy-based material in charging and discharging.

An electrode of a secondary battery is formed using, for example, materials such as an active material, a conductive agent, and a binder. As the proportion of a material that contributes to charge and discharge capacity, e.g., an active material, becomes higher, a secondary battery can have increased capacity. When an electrode includes a conductive agent, the conductivity of the electrode is increased and excellent output characteristics can be obtained. Repeated expansion and contraction of an active material in charging and discharging of a secondary battery may cause separation of the active material, blocking of a conductive path, or the like in an electrode. In such a case, a conductive agent and a binder included in an electrode can inhibit separation of an active material and blocking of a conductive path. Meanwhile, the use of a conductive agent and a binder lowers the proportion of an active material, which might decrease the capacity of a secondary battery.

An object of one embodiment of the present invention is to provide an electrode with excellent characteristics. Another object of one embodiment of the present invention is to provide an active material with excellent characteristics. Another object of one embodiment of the present invention is to provide a novel electrode.

Another object of one embodiment of the present invention is to provide a negative electrode with mechanical strength. Another object of one embodiment of the present invention is to provide a positive electrode with mechanical strength. Another object of one embodiment of the present invention is to provide a negative electrode with high capacity. Another object of one embodiment of the present invention is to provide a positive electrode with high capacity. Another object of one embodiment of the present invention is to provide a negative electrode with little deterioration. Another object of one embodiment of the present invention is to provide a positive electrode with little deterioration.

Another object of one embodiment of the present invention is to provide a secondary battery with little deterioration. Another object of one embodiment of the present invention is to provide a highly safe secondary battery. Another object of one embodiment of the present invention is to provide a secondary battery with high energy density. Another object of one embodiment of the present invention is to provide a novel secondary battery.

Note that the description of these objects does not preclude the existence of other objects. One embodiment of the present invention does not have to achieve all these objects.

Other objects can be derived from the description of the specification, the drawings, and the claims.

### Means for Solving the Problems

An electrode of one embodiment of the present invention includes a particle and a material having a sheet-like shape. The particle includes a first particle and a second particle. The first particle and the material having a sheet-like shape each have a size larger than a particle diameter of the second particle. There is a region where the second particle is positioned between the first particle and the material having a sheet-like shape. There is a region where the first particle and the material having a sheet-like shape are in contact with each other.

An electrode of another embodiment of the present invention includes a particle and a material having a sheet-like shape. The particle includes a first particle and a second particle. The first particle and the material having a sheet-like shape each have a size larger that a particle diameter of the second particle. There is a region where the material having a sheet-like shape is in contact with the first particle so as to cover, surround, or cling to the second particle positioned on a surface of the first particle.

The material having a sheet-like shape includes a first region and the first region is preferably terminated by a hydrogen atom. The first region is, for example, a region containing one atom that can be bonded to hydrogen and a hydrogen atom bonded to the atom. Alternatively, the first region is, for example, a region containing a plurality of atoms that can be bonded to hydrogen.

A hydrogen bond can be formed between the hydrogen atom contained in the first region and an oxygen atom contained in a functional group terminating a surface of the first particle or the second particle.

The material having a sheet-like shape is curved so as to be close to the particle by an intermolecular force, and thus can cling to the particle due to a hydrogen bond. Note that the material having a sheet-like shape preferably includes a plurality of regions terminated by hydrogen atoms in a sheet plane.

Alternatively, the first region may be terminated by a functional group containing oxygen. Examples of the functional group containing oxygen include a hydroxy group, an epoxy group, and a carboxyl group. A hydrogen atom contained in a hydroxy group, a carboxyl group, and the like can form a hydrogen bond with an oxygen atom contained in the functional group terminating the particle. In addition, an oxygen atom contained in a hydroxy group, an epoxy group, and a carboxyl group can form a hydrogen bond with a hydrogen atom contained in the functional group terminating the particle.

In the case where the material having a sheet-like shape includes a second region that is terminated by a fluorine atom, the fluorine atom contained in the second region and a hydrogen atom contained in the functional group terminating the particle can form a hydrogen bond. Accordingly, the material having a sheet-like shape clings to the particle more easily.

The first region sometimes includes a hole formed in the sheet plane and the hole is formed with a plurality of atoms bonded in a ring shape and atoms terminating the plurality of atoms. The plurality of atoms may be terminated by functional groups.

The particle included in the electrode of one embodiment of the present invention preferably functions as an active material, for example. As the particle included in the electrode of one embodiment of the present invention, a material functioning as an active material can be used. Alternatively, the particle included in the electrode of one embodiment of the present invention preferably contains a material functioning as an active material, for example. The material having a sheet-like shape contained in the electrode of one embodiment of the present invention preferably functions as a conductive agent, for example. One embodiment of the present invention can achieve an electrode having high conductivity, because a conductive agent can cling to an active material by a hydrogen bond.

In the electrode of one embodiment of the present invention, it is preferable that the first particle function as a first active material and the second particle function as a second active material. The first particle is preferably an active material with a small volume change in charging and discharging, for example, and preferably has a particle diameter 10 times or more that of the second particle. The material having a sheet-like shape contained in the electrode of one embodiment of the present invention preferably functions as a conductive agent, for example. In one embodiment of the present invention, the material having a sheet-like shape can be in contact with the first particle so as to cover, surround, or cling to the second particle positioned on the surface of the first particle, so that an electrode having high conductivity can be achieved.

The material having a sheet-like shape clings to an active material, whereby separation or the like of the active material in the electrode can be prevented. Moreover, the material having a sheet-like shape can cling to a plurality of active materials. In the case where a material with a large volume change in charging and discharging, e.g., silicon, is used as the active material, the adhesion between the active material and the conductive agent, between the plurality of active materials, and the like is gradually weakened due to repeated charging and discharging, which might cause separation or the like of the active material of the electrode. In the case where silicon is used as the second particle in one embodiment of the present invention, the material having a sheet-like shape can be in contact with the first particle so as to cover, surround, or cling to the second particle positioned on the surface of the first particle with a small volume change in charging and discharging. Silicon has an extremely high theoretical capacity of 4000 mAh/g or higher and can increase the energy density of a secondary battery. An active material with a small volume change in charging and discharging is used as the first particle and a material containing silicon is used as the second particle in one embodiment of the present invention, so that a highly reliable secondary battery that has a high energy density and stable characteristics even in repeated charging and discharging can be achieved.

The second particle of one embodiment of the present invention contains a silicon atom terminated by a hydroxy group. The particle of another embodiment of the present invention contains silicon and at least part of the surface of which is terminated by a hydroxy group. The particle of another embodiment of the present invention is a silicon compound at least part of the surface of which is terminated by a hydroxy group. The particle of another embodiment of the present invention is silicon at least part of the surface of which is terminated by a hydroxy group.

In one embodiment of the present invention, it is preferable that the first particle contain a first material and the second particle contain a second material.

In the above structure, the first material is preferably one or more selected from graphite, graphitizing carbon, non-graphitizing carbon, carbon nanotube, carbon black, and graphene.

In the above structure, a metal or a compound containing one or more elements selected from silicon, tin, gallium, aluminum, germanium, lead, antimony, bismuth, silver, zinc, cadmium, and indium is preferably contained as the second material.

A graphene compound is preferably used as the material having a sheet-like shape. As the graphene compound, graphene in which a carbon atom in a sheet plane are terminated by an atom other than carbon or a functional group is preferably used, for example.

Graphene has a structure with its edge terminated by hydrogen. A graphene sheet has a two-dimensional structure formed of six-membered rings of carbon, and when a defect or a hole is formed in the two-dimensional structure, a carbon atom in the vicinity of the defect or a carbon atom forming the hole is terminated by any of various functional groups or an atom such as a hydrogen atom or a fluorine atom, in some cases.

In one embodiment of the present invention, a defect or a hole is formed in graphene, and a carbon atom in the vicinity of the defect or a carbon atom forming the hole is terminated by a hydrogen atom, a fluorine atom, a functional group containing a hydrogen atom or a fluorine atom, a functional group containing oxygen, or the like, whereby graphene can cling to a particle included in the electrode. Note that the defect or the hole formed in graphene preferably exists in an amount that does not significantly impair the conductivity of the whole graphene. Here, atoms “forming a hole” indicates, for example, atoms around an opening, atoms in end portions of the opening, and the like.

A graphene compound of one embodiment of the present invention includes a hole formed with a many-membered ring such as a 7-or more-membered ring composed of carbon atoms, preferably a 18-or more-membered ring composed of carbon atoms, further preferably a 22-or more-membered ring composed of carbon atoms. One of carbon atoms in the many-membered ring is terminated by a hydrogen atom. Moreover, in one embodiment of the present invention, one carbon atom in the many-membered ring is terminated by a hydrogen atom, and another carbon atom in the many-membered ring is terminated by a fluorine atom. Furthermore, in one embodiment of the present invention, the number of carbon atoms in the many-numbered ring that are terminated by fluorine is less than 40% of the number of carbon atoms that are terminated by hydrogen atoms.

The graphene compound of one embodiment of the present invention includes a hole, and the hole is formed by a plurality of carbon atoms bonded in a ring shape, atoms or functional groups that terminate the plurality of carbon atoms, and the like. A Group 13 element such as boron, a Group 15 element such as nitrogen, and a Group 16 element such as oxygen may substitute for one or more of the plurality of carbon atoms bonded in a ring shape.

In the graphene compound of one embodiment of the present invention, a carbon atom except for a carbon atom in the edge is preferably terminated by a hydrogen atom, a fluorine atom, a functional group containing a hydrogen atom or a fluorine atom, a functional group containing oxygen, or the like. In the graphene compound of one embodiment of the present invention, for example, a carbon atom in the vicinity of the center of a graphene plane is preferably terminated by a hydrogen atom, a fluorine atom, a functional group containing a hydrogen atom or a fluorine atom, a functional group containing oxygen, or the like.

One embodiment of the present invention is an electrode including a first active material, a second active material, and a graphene compound. The first active material contains silicon with a particle diameter of less than or equal to 1 μm. The second active material contains graphite larger than the first active material. The first active material is positioned on a surface of the second active material. The graphene compound is in contact with the first active material and the second active material.

In any of the electrodes described above, the graphene compound is preferably in contact with the second active material so as to cover the first active material.

In any of the electrodes described above, the graphene compound is preferably in contact with the second active material so as to cling to the first active material.

In any of the electrodes described above, the first active material is preferably positioned between the second active material and the graphene compound.

In any of the electrodes described above, a size of the second active material is preferably 10 times or more a size of the first active material.

In any of the electrodes described above, silicon preferably contains amorphous silicon.

In any of the electrodes described above, it is preferable that the graphene compound include a hole, a plurality of carbon atoms, and one or more hydrogen atoms, the one or more hydrogen atoms each terminate any one of the plurality of carbon atoms, and the plurality of carbon atoms and the one or more hydrogen atom form the hole.

Another embodiment of the present invention is a secondary battery including any of the electrodes described above and an electrolyte.

Another embodiment of the present invention is a moving vehicle including any of the secondary batteries described above.

Another embodiment of the present invention is an electronic device including any of the secondary batteries described above.

Another embodiment of the present invention is a method for fabricating an electrode of a lithium-ion secondary battery, including: a first step of mixing silicon and a solvent to fabricate a first mixture; a second step of mixing the first mixture and graphite to fabricate a second mixture; a third step of mixing the second mixture and a graphene compound to fabricate a third mixture; a fourth step of mixing the third mixture, a precursor of polyimide, and the solvent to fabricate a fourth mixture; a fifth step of applying the fourth mixture onto a metal foil; a sixth step of drying the fourth mixture; and a seventh step of heating the fourth mixture to fabricate the electrode, in which the heating is performed under a reduced-pressure environment to reduce the graphene compound and imidize the precursor of polyimide.

In the above structure, the graphene compound preferably contains graphene oxide and the graphite is preferably 10 times or more as large as the silicon.

### Effect of the Invention

According to one embodiment of the present invention, an electrode with excellent characteristics can be provided. According to another embodiment of the present invention, a novel electrode can be provided.

According to another embodiment of the present invention, a negative electrode with mechanical strength can be provided. According to another embodiment of the present invention, a durable positive electrode can be provided. According to another embodiment of the present invention, a negative electrode with little deterioration can be provided. According to another embodiment of the present invention, a positive electrode with little deterioration can be provided. According to another embodiment of the present invention, a negative electrode with little deterioration can be provided. According to another embodiment of the present invention, a positive electrode with little deterioration can be provided.

According to another embodiment of the present invention, a secondary battery with little deterioration can be provided. According to another embodiment of the present invention, a highly safe secondary battery can be provided. According to another embodiment of the present invention, a secondary battery with high energy density can be provided. According to another embodiment of the present invention, a novel secondary battery can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1A and FIG. 1B are diagrams illustrating an example of a cross section of an electrode.

FIG. 1C is a perspective view illustrating particles.

FIG. 2A and FIG. 2B are diagrams illustrating change in shape of a particle in charging and discharging.

FIG. 3A and FIG. 3B show examples of models of a graphene compound.

FIG. 4 is a diagram showing an example of a method for fabricating an electrode of one embodiment of the present invention.

FIG. 5 is a diagram illustrating crystal structures of a positive electrode active material.

FIG. 6 is a diagram illustrating crystal structures of a positive electrode active material.

FIG. 7 is a diagram illustrating an example of a cross section of a secondary battery.

FIG. 8A is an exploded perspective view of a coin-type secondary battery, FIG. 8B is a perspective view of the coin-type secondary battery, and FIG. 8C is a cross-sectional perspective view thereof.

FIG. 9A and FIG. 9B are examples of a cylindrical secondary battery, FIG. 9C is an example of a plurality of cylindrical secondary batteries, and FIG. 9D is an example of a power storage system including a plurality of cylindrical secondary batteries.

FIG. 10A and FIG. 10B are diagrams illustrating examples of a secondary battery, and FIG. 10C is a diagram illustrating the internal state of the secondary battery.

FIG. 11A, FIG. 11B, and FIG. 11C are diagrams illustrating an example of a secondary battery.

FIG. 12A and FIG. 12B are diagrams illustrating external views of secondary batteries.

FIG. 13A, FIG. 13B, and FIG. 13C are diagrams illustrating a method for fabricating a secondary battery.

FIG. 14A is a perspective view illustrating a battery pack, FIG. 14B is a block diagram of the battery pack, and FIG. 14C is a block diagram of a vehicle including a motor.

FIG. 15A to FIG. 15D are diagrams illustrating examples of transport vehicles.

FIG. 16A and FIG. 16B are diagrams illustrating power storage devices.

FIG. 17A to FIG. 17D are diagrams illustrating examples of electronic devices.

FIG. 18A and FIG. 18B are SEM images.

FIG. 19A and FIG. 19B are SEM images.

FIG. 20A and FIG. 20B are SEM images.

FIG. 21A and FIG. 21B are SEM images.

FIG. 22A and FIG. 22B are diagrams showing cycle performance.

FIG. 23 is a diagram showing the relationship between an electrode compounding ratio and cycle performance.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

In the drawings, the size, the layer thickness, or the region is exaggerated for clarity in some cases. Therefore, they are not limited to the illustrated scale.

The ordinal numbers such as “first” and “second” in this specification and the like are used for convenience and do not denote the order of steps or the stacking order of layers. Therefore, for example, the term “first” can be replaced with the term “second”, “third”, or the like as appropriate. In addition, the ordinal numbers in this specification and the like do not sometimes correspond to the ordinal numbers that are used to specify one embodiment of the present invention.

### Embodiment 1

In this embodiment, an electrode, an active material, a conductive agent, and the like of one embodiment of the present invention are described.

### Example of Electrode

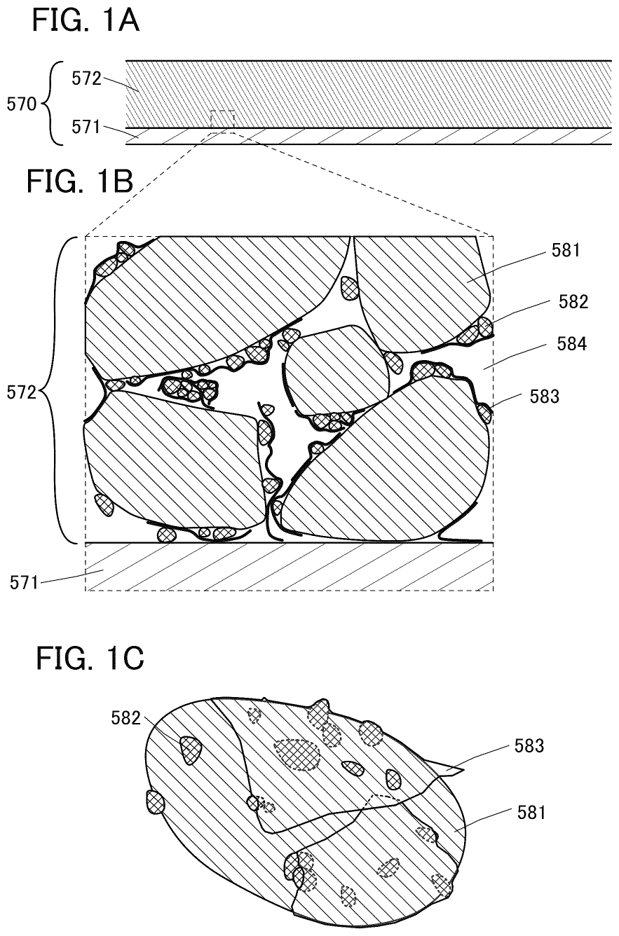

FIG. 1A is a schematic cross-sectional view illustrating an electrode of one embodiment of the present invention. An electrode 570 illustrated in FIG. 1A can be applied to a positive electrode and/or a negative electrode included in a secondary battery. The electrode 570 includes at least a current collector 571 and an active material layer 572 formed in contact with the current collector 571.

FIG. 1B is an enlarged view of a region surrounded by a dashed line in FIG. 1A. As illustrated in FIG. 1B, the active material layer 572 includes a first particle 581, a second particle 582, a graphene compound 583, and an electrolyte 584. The graphene compound 583 has a sheet-like shape. FIG. 1C is a schematic view illustrating a state where the graphene compound 583 is in contact with the first particle 581 so as to cover, surround, or cling to the second particle 582 positioned on a surface of the first particle 581. A material functioning as an active material can be used as the first particle 581 and the second particle 582. Alternatively, at least the second particle 582 preferably includes a material functioning as an active material. In addition, the graphene compound 583 included in the electrode 570 preferably functions as a conductive agent. In the case where the graphene compound 583 is used as a conductive agent in one embodiment of the present invention, the graphene compound 583 can cling to an active material owing to a hydrogen bond, whereby an electrode with high conductivity can be achieved.

A variety of materials can be used as the first particle 581 and the second particle 582. In the case where a particle of one embodiment of the present invention is used as the first particle 581 and the second particle 582, as illustrated in FIG. 1B and FIG. 1C, the affinity of the first particle 581 and the second particle 582 with the graphene compound 583 is improved; accordingly, as illustrated in FIG. 1B and FIG. 1C, the graphene compound 583 can be in contact with the first particle 581 so as to cover, surround, or cling to the second particle 582 positioned on the surface of the first particle 581. As the particle of one embodiment of the present invention, it is possible to use, for example, a particle whose surface portion contains fluorine or a functional group containing oxygen, or a particle whose surface includes a region terminated by a fluorine atom or a functional group containing oxygen. Since the graphene compound 583 can cling to the first particle 581 and the second particle 582, an electrode with high conductivity can be achieved. The state of being in contact with something so as to cling to it can be rephrased as a state of being in close contact with it, not making point contact with it. Alternatively, it can also be rephrased as a state of being in contact with a particle along its surface. Alternatively, it can be rephrased as a state of making surface contact with a plurality of particles. Materials that can be used as the first particle 581 and the second particle 582 will be described later.

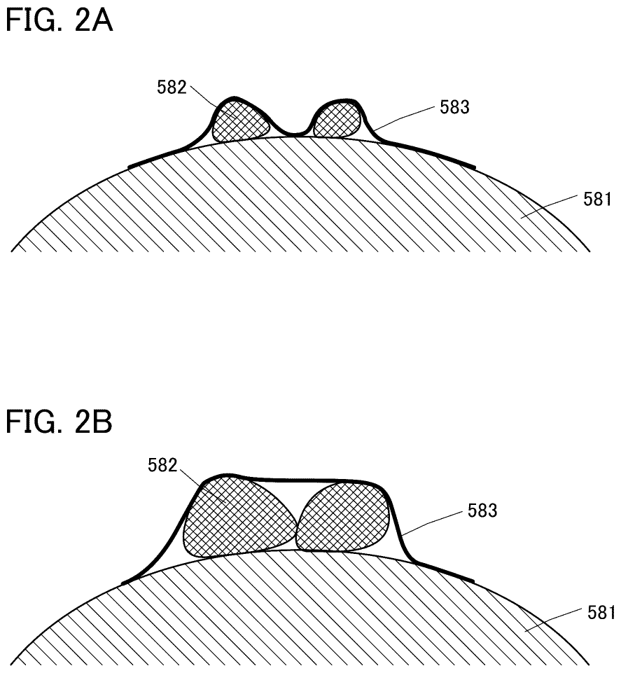

A case where an active material with a large volume change in charging and discharging is used as the second particle 582 is described with reference to FIG. 2. FIG. 2A illustrates a state where the first particle 581, the second particle 582, and the graphene compound 583 as a material having a sheet-like shape are included, and the graphene compound 583 is in contact with the first particle 581 so as to cover, surround, or cling to the second particle 582 positioned on the surface of the first particle 581. It can also be said that the second particle 582 is positioned between the first particle 581 and the graphene compound 583, and the graphene compound 583 is in contact with the first particle 581 and the second particle 582. FIG. 2B illustrates a case where the volume of the second particle 582 illustrated in FIG. 2A is increased by charging or discharging. Since the graphene compound 583 is in contact with the first particle 581 so as to cover, surround, or cling to the second particle 582 positioned on the surface of the first particle 581, electrical contact between the second particle 582 and the first particle 581 can be maintained even after the volume of the second particle 582 is increased by charging or discharging. Furthermore, separation of the active material of the electrode can be inhibited.

In the case where the graphene compound 583 is in contact with the active materials such as the first particle 581 and the second particle 582 so as to cling to them, a contact area between the graphene compound 583 and the active materials is increased, so that conductivity of electrons moving through the graphene compound 583 is increased. In the case where the volume of the active materials largely change in charging and discharging, the graphene compound 583 in contact with the active materials so as to cling to them can effectively prevent detachment of the active material. These effects can be obtained significantly in the case where the graphene compound 583 is in contact with the active materials so as to tightly cling to them. The graphene compound 583 includes a hole that is large enough for Li ions to pass through, and desirably includes many holes to the extent that the electron conductivity of the graphene compound 583 is not hindered.

Although an example of using the graphene compound 583 as a material having a sheet-like shape is described here, the material having a sheet-like shape is not limited to the graphene compound 583; another material having a sheet-like shape and high electron conductivity may be used.

The active material layer 572 can include a carbon-based material such as carbon black, graphite, carbon fiber, or fullerene in addition to the graphene compound 583. As the carbon black, acetylene black (AB) can be used, for example. As the graphite, natural graphite or artificial graphite such as mesocarbon microbeads can be used, for example. These carbon-based materials have high conductivity and can function as a conductive agent in the active material layer. Note that these carbon-based materials may each function as an active material.

As carbon fiber, mesophase pitch-based carbon fiber, isotropic pitch-based carbon fiber, or the like can be used, for example. As the carbon fiber, carbon nanofiber, carbon nanotube, or the like can be used. Carbon nanotube can be formed by, for example, a vapor deposition method.

The active material layer may include, as a conductive agent, metal powder or metal fiber of copper, nickel, aluminum, silver, gold, or the like, a conductive ceramic material, or the like.

The content of the conductive additive to the total amount of solid content in the active material layer is preferably greater than or equal to 0.5 wt % and less than or equal to 10 wt %, and further preferably greater than or equal to 0.5 wt % and less than or equal to 5 wt %.

Unlike a particulate conductive agent such as carbon black, which makes point contact with an active material, the graphene compound 583 is capable of making low-resistance surface contact; accordingly, the electrical conductivity with the particulate active material can be improved with a smaller amount of the conductive agent in the case of using the graphene compound 583 than the case of using a normal conductive agent. This can increase the proportion of the active material in the active material layer. Thus, discharge capacity of the secondary battery can be increased.

Furthermore, the graphene compound 583 of one embodiment of the present invention has excellent permeability to lithium; therefore, the charge and discharge rate of the secondary battery can be increased.

A particulate carbon-containing compound such as carbon black or graphite and a fibrous carbon-containing compound such as carbon nanotube easily enter a microscopic space. A microscopic space refers to, for example, a region between a plurality of active materials. When a carbon-containing compound that easily enters a microscopic space and a sheet-like, carbon-containing compound such as graphene that can impart conductivity to a plurality of particles are used in combination, the density of the electrode increases and an excellent conductive path can be formed. When the secondary battery includes the electrolyte of one embodiment of the present invention, the secondary battery can be operated more stably. That is, the secondary battery of one embodiment of the present invention can have both high energy density and stability, and is useful as an in-vehicle secondary battery. When a vehicle becomes heavier with increasing number of secondary batteries, more energy is required to move the vehicle, which shortens the driving range. With use of a secondary battery with high density, the driving range can be increased even with the same weight of secondary batteries included in the vehicle, that is, even with the same total weight of the vehicle.

Furthermore, an in-vehicle secondary battery with high capacity requires more power for charging, so that charging is preferably ended in a short time. What is called a regenerative charging, in which electric power temporarily generated when the vehicle is braked is used for charging, is performed under high rate charging conditions; thus, an in-vehicle secondary battery is desired to have favorable rate characteristics.

With use of an electrolyte of one embodiment of the present invention, an in-vehicle secondary battery having a wide operation temperature range can be obtained.

In addition, the secondary battery of one embodiment of the present invention can be downsized owing to its high energy density, and can be charged fast owing to its high conductivity. Thus, the structure of the secondary battery of one embodiment of the present invention is useful also in a portable information terminal.

The active material layer 572 preferably includes a binder (not illustrated). The binder binds or fixes the electrolyte and the active materials, for example. In addition, the binder can bind or fix the electrolyte and a carbon-based material, the active material and a carbon-based material, a plurality of active materials, a plurality of carbon-based materials, or the like.

As the binder, it is preferable to use a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose.

Polyimide has extremely excellent thermal, mechanical, and chemical stability. In the case of using polyimide as a binder, a dehydration reaction and a cyclization (imidizing) reaction are performed. These reactions can be performed by heat treatment, for example. In an electrode of one embodiment of the present invention, when graphene including a functional group containing oxygen and polyimide are used as the graphene compound and the binder, respectively, the graphene compound can also be reduced by the heat treatment, leading to simplification of the process. Because of high heat-resistance, heat treatment can be performed at a heat temperature of 200° C. or higher. The heat treatment at a heat temperature of 200° C. or higher allows the graphene compound to be reduced sufficiently and the conductivity of the electrode to increase.

A fluorine polymer which is a high molecular material containing fluorine, specifically, polyvinylidene fluoride (PVDF) can be used, for example. PVDF is a resin having a melting point in the range of higher than or equal to 134° C. and lower than or equal to 169° C., and is a material with excellent thermal stability.

As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used. Alternatively, fluororubber can be used as the binder.

As the binder, for example, water-soluble polymers are preferably used. As the water-soluble polymers, a polysaccharide or the like can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above-described rubber materials.

Two or more of the above-described materials may be used in combination for the binder.

The graphene compound 583 has flexibility and can cling to the second particle 582, like natto (fermented soybeans). For example, the second particle 582 and the graphene compound 583 can be likened to a soybean and a sticky ingredient, e.g., polyglutamic acid, respectively. By providing the graphene compound 583 as a bridge between materials included in the active material layer 572, such as the electrolyte, the plurality of active materials such as the second particles 582, and the plurality of carbon-based materials, it is possible to not only form an excellent conductive path in the active material layer 572 but also bind or fix the materials with use of the graphene compound 583. In addition, for example, a three-dimensional net-like structure or an arrangement structure of polygons, e.g., a honeycomb structure in which hexagons are arranged in matrix, is formed using the plurality of graphene compounds 583, and materials such as the electrolyte, the plurality of active materials, and the plurality of carbon-based materials are placed in meshes, whereby the graphene compounds 583 form a three-dimensional conductive path and detachment of an electrolyte from the current collector can be suppressed. In the arrangement structure of polygons, polygons with different number of sides may be intermingled. Thus, in the active material layer 572, the graphene compound 583 functions as a conductive agent and may also function as a binder.

The first particle 581 and the second particle 582 can each have any of various shapes such as a rounded shape and an angular shape. In addition, on the cross section of the electrode, the first particle 581 and the second particle 582 can each have any of various cross-sectional shapes such as a circle, an ellipse, a shape having a curved line, and a polygon. For example, FIG. 1B and FIG. 1C illustrate an example where the first particle 581 of the particle 582 and a second cross section have a rounded shape; however, the cross sections of the first particle 581 and the second particle 582 may each be angular. Alternatively, one part may be rounded and another part may be angular.

### Graphene Compound

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group containing oxygen. The graphene compound preferably has a bent shape. A graphene compound may be rounded like carbon nanofiber.

In this specification and the like, for example, graphene oxide contains carbon and oxygen, has a sheet-like shape, and includes a functional group, in particular, an epoxy group, a carboxy group, or a hydroxy group.

In this specification and the like, for example, reduced graphene oxide contains carbon and oxygen, has a sheet-like shape, and has a two-dimensional structure formed of a six-membered ring composed of carbon atoms. The reduced graphene oxide may also be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced oxide graphene oxide is preferably 1 or more. The reduced graphene oxide with such an intensity ratio can function as a conductive material with high conductivity even with a small amount.

The reduced graphene oxide can sometimes be provided with holes by reduction of graphene oxide.

A material obtained by terminating an edge portion of graphene with fluorine may be used as the graphene compound.

In the longitudinal cross section of the active material layer, the sheet-like graphene compounds are dispersed substantially uniformly in a region inside the active material layer. The plurality of graphene compounds are formed to partly cover a plurality of particulate active materials or adhere to the surfaces of the plurality of particulate active materials, so that the graphene compounds make surface contact with the particulate active materials.

Here, the plurality of graphene compounds can be bonded to each other to form a net-like graphene compound sheet (hereinafter, referred to as a graphene compound net or a graphene net). A graphene net that covers the active material can function as a binder for bonding the active materials. Accordingly, the amount of the binder can be reduced, or the binder does not have to be used. This can increase the proportion of the active material in the electrode volume and the electrode weight. That is, the charge and discharge capacity of the secondary battery can be increased.

Here, after graphene oxide used as the graphene compound is mixed with the active material to form a layer to be the active material layer, the graphene oxide is preferably reduced. That is, the formed active material layer preferably contains reduced graphene oxide. When graphene oxide with extremely high dispersibility in a polar solvent is used to form the active material layer including the graphene compounds, the graphene compounds can be substantially uniformly dispersed in a region inside the active material layer.

In an active material layer formed in such a manner that a dispersion liquid in which graphene oxide is substantially uniformly dispersed in a solvent is applied on a current collector, the solvent is removed by volatilization, and then the graphene oxide is reduced, the graphene compounds included in the active material layer partly overlap with each other. As described above, the reduced graphene oxides are dispersed to make surface contact with each other, whereby a three-dimensional conductive path can be formed. Note that graphene oxide may be reduced by heat treatment or with use of a reducing agent, for example.

Alternatively, a conductive path can be formed in the following manner: the surface of the active material is covered with a graphene compound in advance to form a conductive covering film on the surface of the active material, and the active materials are electrically connected to each other by the graphene compound.

A graphene compound of one embodiment of the present invention preferably includes a hole in part of a carbon sheet. In the graphene compound of one embodiment of the present invention, a hole through which carrier ions such as lithium ions can pass is provided in part of a carbon sheet, which can facilitate insertion and extraction of carrier ions in the surface of an active material covered with the graphene compound to increase the rate characteristics of a secondary battery. The hole provided in part of the carbon sheet is referred to as a vacancy, a defect, or a gap in some cases.

A graphene compound of one embodiment of the present invention preferably includes a hole formed by a plurality of carbon atoms and one or more fluorine atoms. Furthermore, the plurality of carbon atoms are preferably bonded to each other in a ring shape and one or more of the plurality of carbon atoms bonded to each other in a ring shape are preferably terminated by fluorine. Fluorine has high electronegativity and is easily negatively charged. Approach of positively-charged lithium ions causes interaction, whereby energy is stable and the barrier energy in passage of lithium ions through the hole can be lowered. Thus, fluorine forming the hole in a graphene compound allows a lithium ion to easily pass through even a small hole; therefore, the graphene compound can have excellent conductivity. One or more of the carbon atoms bonded to each other in a ring shape may be terminated by hydrogen.

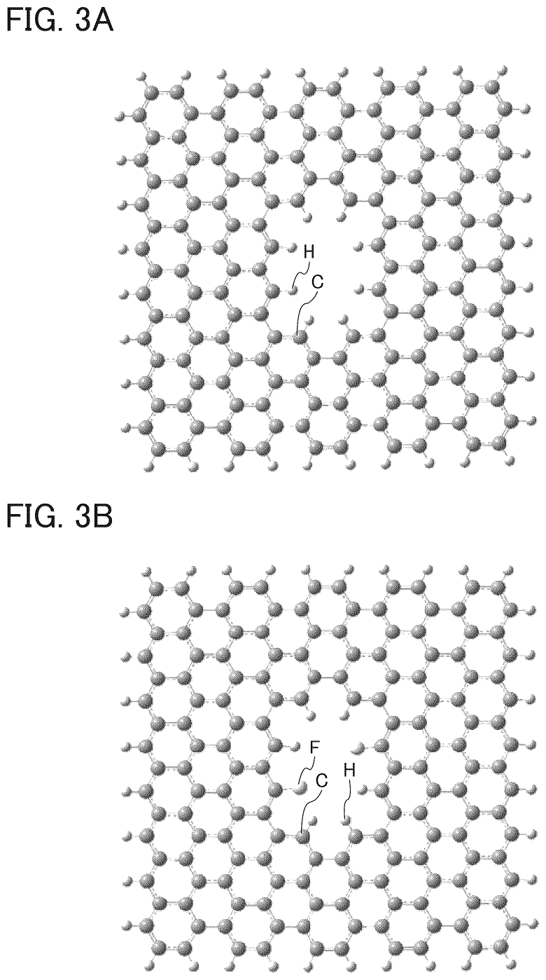

FIG. 3A and FIG. 3B each illustrate an example of a structure of a graphene compound including a hole.

The structure illustrated in FIG. 3A includes a 22-membered ring, and eight carbon atoms of carbon atoms contained in the 22-membered ring are each terminated by hydrogen. In the structure, it can be said that two connected six-membered rings are removed from graphene and carbon atoms bonded to the removed six-membered rings are terminated by hydrogen.

The structure illustrated in FIG. 3B includes a 22-membered ring, and six carbon atoms of eight carbon atoms of carbon atoms contained in the 22-membered ring are terminated by hydrogen, and two carbon atoms thereof are terminated by fluorine. In the structure, it can be said that two connected six-membered rings are removed from graphene and carbon atoms bonded to the removed six-membered rings is terminated by hydrogen or fluorine.

Silicon terminated by a hydroxyl group forms a hydrogen bond between hydrogen contained in the hydroxyl group on the surface of the silicon and a hydrogen atom contained in the graphene compound or a fluorine atom contained in the graphene compound, which indicates strong interaction between the silicon terminated by a hydroxyl group and a graphene compound including a hole.

When the graphene compound contains fluorine as well as hydrogen, it is indicated that in addition to the hydrogen bond between an oxygen atom of the hydroxy group and a hydrogen atom of the graphene compound, the hydrogen bond between a hydrogen atom of the hydroxy group and a fluorine atom of the graphene compound is also formed, thereby making the interaction between the particle containing silicon and the graphene compound stronger and more stable.

For example, in the case where graphene includes a hole, it is possible that a spectrum based on a feature caused by the hole is observed in Raman spectroscopic mapping measurement. Furthermore, it is possible that a bond, a functional group, and the like included in the hole are observed with ToF-SIMS. It is also possible that the vicinity, surrounding, and the like of the hole are analyzed in TEM observation.

### Example of Negative Electrode Active Material

In the case where the electrode 570 is a negative electrode, a particle including a negative electrode active material can be used as the second particle 582. As the negative electrode active material, a material that can react with carrier ions of the secondary battery, a material into and from which carrier ions can be inserted and extracted, a material that enables an alloying reaction with a metal serving as a carrier ion, a material that enables melting and precipitation of a metal serving as a carrier ion, or the like is preferably used.

Examples of the negative electrode active material will be described below.

Silicon can be used as the negative electrode active material. In the electrode 570, a particle containing silicon is preferably used as the second particle 582.

In addition, a metal or a compound containing one or more elements selected from tin, gallium, aluminum, germanium, lead, antimony, bismuth, silver, zinc, cadmium, and indium, can be used as the negative electrode active material included in the second particle 582. Examples of an alloy-based compound containing such elements include Mg₂Si, Mg₂Ge, Mg₂Sn, SnS₂, V₂Sn₃, FeSn₂, CoSn₂, Ni₃Sn₂, Cu₆Sns, Ag₃Sn, Ag₃Sb, Ni₂MnSb, CeSb₃, LaSn₃, La₃Co₂Sn₇, CoSb₃, InSb, and SbSn.

A material whose resistance is lowered by addition of an impurity element such as phosphorus, arsenic, boron, aluminum, or gallium to silicon may be used. Furthermore, a silicon material pre-doped with lithium may be used. Examples of a pre-doping method include annealing of a mixture of silicon with lithium fluoride, lithium carbonate, or the like and mechanical alloying of a lithium metal and silicon. A secondary battery may be fabricated in the following manner: an electrode is formed; lithium doping is performed through charge and discharge reaction with a combination of the formed electrode and an electrode of a lithium metal or the like; and then the electrode subjected to doping is combined with a counter electrode (e.g., a positive electrode for a negative electrode subjected to pre-doping).

For example, a nanosilicon particle can be used as the second particle 582. The average diameter of nanosilicon particles is, for example, preferably greater than or equal to 5 nm and less than 1 μm, further preferably greater than or equal to 10 nm and less than or equal to 300 nm, still further preferably greater than or equal to 10 nm and less than or equal to 100 nm.

The nanosilicon particle may have a spherical shape, a flattened spherical shape, or a rectangular solid shape with rounded corners. The size of the nanosilicon particle, which is measured as D50 by a laser diffraction particle size distribution measurement, is preferably greater than or equal to 5 nm and less than 1 μm, further preferably greater than or equal to 10 nm and less than or equal to 300 nm, still further preferably greater than or equal to 10 nm and less than or equal to 100 nm, for example. Here, D50 is a particle diameter when the accumulated amount of particles accounts for 50% of an accumulated particle amount curve which is the result of the particle size distribution measurement. In other words, D50 is a median. The particle size distribution measurement is not limited to a laser diffraction particle size distribution measurement; in the case where the particle size is below the lower measurement limit of the laser diffraction particle size distribution measurement, the major diameter of the cross section of the particle may be measured by SEM or TEM analysis.

The nanosilicon particle preferably contains amorphous silicon. The nanosilicon particle preferably contains polycrystalline silicon. The nanosilicon particle preferably contains amorphous silicon and polycrystalline silicon. The nanosilicon particle may include a region with crystallinity and an amorphous region.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain(s). The silicon oxide may be amorphous. A particle in which a graphene compound cling to a secondary particle of silicon may be used.

As a compound containing silicon, Li₂SiO₃ and Li₄SiO₄ may be included, for example. Each of Li₂SiO₃ and Li₄SiO₄ may have crystallinity, or may be amorphous.

The analysis of the compound containing silicon can be performed by NMR, XRD, Raman spectroscopy, SEM, TEM, EDX, or the like.

The first particle 581 included in the electrode 570 preferably contains graphite.

The first particle 581 preferably functions as a negative electrode active material, further preferably is a material with a small volume change in charging and discharging.

As for the volume change of the first particle 581 in charging or discharging, the maximum volume in charging or discharging as compared to the minimum volume in charging or discharging being 1 is preferably less than or equal to 2, further preferably less than or equal to 1.5, still further preferably less than or equal to 1.1.

The particle diameter of the first particle 581 is desirably larger than the particle diameter of the second particle 582.

For example, in a laser diffraction particle size distribution measurement, the D50 of the first particle 581 is preferably more than or equal to 1.5 times and less than 1000 times, further preferably more than or equal to 2 times and less than or equal to 500 times, still further preferably more than or equal to 10 times and less than or equal to 100 times the D50 of the second particle 582. Here, D50 is a particle diameter when the accumulated amount of particles accounts for 50% of an accumulated particle amount curve which is the result of the particle size distribution measurement. In other words, D50 is a median. Note that the particle size distribution measurement is not limited to a laser diffraction particle size distribution measurement, and the diameter of the cross section of the particle may be measured by SEM or TEM analysis.

As the first particle 581, it is possible to use, for example, a carbon-based material such as graphite, graphitizing carbon, non-graphitizing carbon, carbon nanotube, carbon black, or a graphene compound, which has a small volume change in charging and discharging.

Furthermore, as the first particle 581, an oxide containing one or more elements selected from titanium, niobium, tungsten, and molybdenum can be used, for example.

As the first particle 581, a combination of two or more of the above-described metals, materials, compounds, and the like can be used.

As the first particle 581, an oxide such as SnO, SnO₂, titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used, for example.

Alternatively, a material that causes a conversion reaction can be used as the first particle 581. For example, a transition metal oxide that does not cause an alloying reaction with lithium, such as cobalt oxide (CoO), nickel oxide (NiO), and iron oxide (FeO), may be used as the first particle 581. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides may be used as the positive electrode material because of its high potential.

### Method for Fabricating Electrode

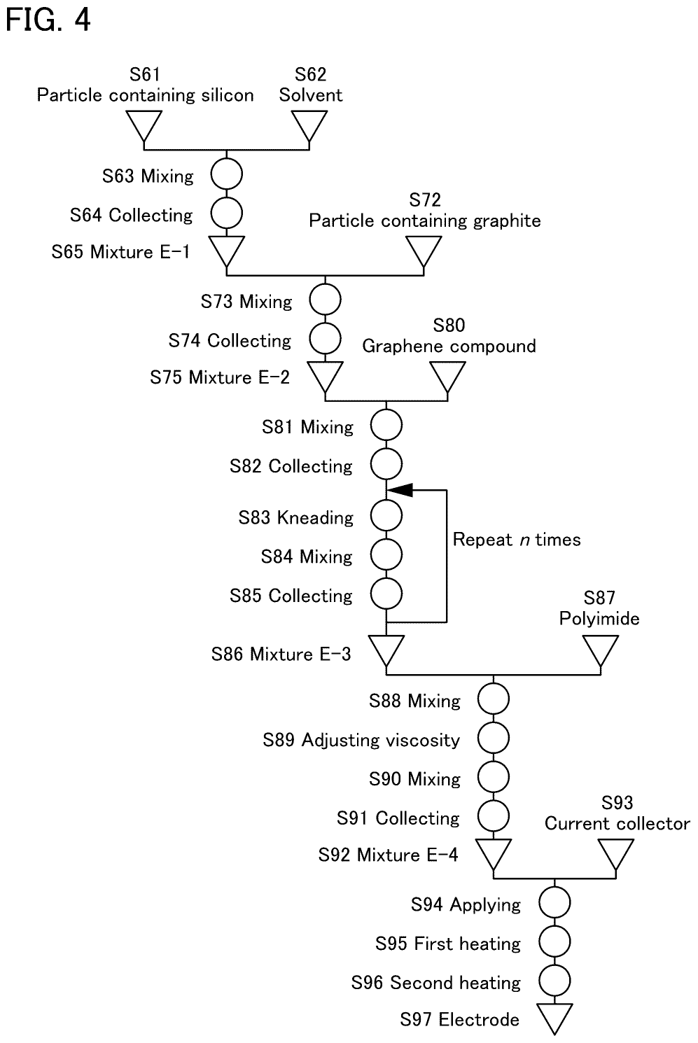

FIG. 4 is a flow chart showing an example of a method for fabricating an electrode of one embodiment of the present invention.

First, a particle containing silicon is prepared as the second particle 582 in Step S61. As the particle containing silicon, the particle mentioned above as the second particle 582 can be used.

In Step S62, a solvent is prepared. For example, one of water, methanol, ethanol, acetone, tetrahydrofuran (THF), dimethylformamide (DMF), N-methylpyrrolidone (NMP), and dimethyl sulfoxide (DMSO), or a mixed solution of two or more of the above can be used as the solvent.

Next, the particle containing silicon prepared in Step S61 and the solvent prepared in Step S62 are mixed in Step S63 and the mixture is collected in Step S64, so that a mixture E-1 is obtained in Step S65. A kneader or the like can be used for the mixing. As the kneader, a planetary centrifugal mixer can be used, for example.

Next, a particle containing graphite is prepared as the first particle 581 in Step S72. As the particle containing graphite, the particle mentioned above as the first particle 581 can be used.

Next, the mixture E-1 and the particle containing graphite prepared in Step S72 are mixed in Step S73 and the mixture is collected in Step S74, so that a mixture E-2 is obtained in Step S75. A kneader or the like can be used for the mixing. As the kneader, a planetary centrifugal mixer can be used, for example.

Then, a graphene compound is prepared in Step S80.

Next, the mixture E-2 and the graphene compound prepared in Step S80 are mixed in Step S81 and the mixture is collected in Step S82. The collected mixture preferably has a high viscosity. Because of the high viscosity, stiff kneading (kneading in high viscosity) can be performed in the following Step S83.

Next, stiff kneading is performed in Step S83. The stiff kneading can be performed with use of a spatula, for example. By performing the stiff kneading, a mixture with high dispersibility of the graphene compound, in which the particle containing silicon and the graphene compound are mixed well, can be formed.

Next, mixing of the stiff-kneaded mixture is performed in Step S84. The kneader or the like can be used for the mixing, for example. The mixture subjected to the mixing is collected in Step S85.

The steps of Step S83 to Step 85 are preferably repeated n times on the mixture collected in Step S85. For example, n is a natural number of greater than or equal to 2 and less than or equal to 10. In the step of Step S83, when the mixture is dried, a solvent is preferably added thereto. However, when a solvent is added too much, the viscosity is lowered and the effect of stiff-kneading is decreased.

Step S83 to Step S85 are repeated n times, and then a mixture E-3 is obtained (Step S86).

Next, a binder is prepared in Step S87. As the binder, any of the above-described materials can be used, and especially polyimide is preferable. Note that in Step S87, a precursor of a material used as the binder is prepared in some cases. For example, a precursor of polyimide is prepared.

Next, in Step S88, the mixture E-3 is mixed with the binder prepared in Step S87. Then, in Step S89, the viscosity is adjusted. Specifically, for example, a solvent of the same kind as the solvent prepared in Step S62 is prepared and is added to the mixture obtained in Step S88. By adjusting the viscosity, for example, the thickness, density, and the like of the electrode obtained in Step S97 can be adjusted in some cases.

Next, the mixture whose viscosity is adjusted in Step S89 is mixed in Step S90 and collected in Step S91, so that a mixture E-4 is obtained (Step S92). The mixture E-4 obtained in Step S92 is referred to as a slurry, for example.

Next, a current collector is prepared in Step S93.

In Step S94, the mixture E-4 is applied on the current collector prepared in Step S93. For the application, a slot die method, a gravure method, a blade method, or combination of any of the methods can be used, for example. Furthermore, a continuous coater or the like may be used for the application.

Next, first heating is performed in Step S95. By the first heating, the solvent is volatilized. The first heating is preferably performed at a temperature in the range from 40° C. to 200° C. inclusive, preferably 50° C. to 150° C. inclusive. Note that the first heating is referred to as drying in some cases.

The first heat treatment may be performed using a hot plate at 30° C. or higher and 70° C. or lower in an air atmosphere for 10 minutes or longer, and then, for example, heat treatment may be performed at room temperature or higher and 100° C. or lower in a reduced-pressure environment for 1 hour or longer and 10 hours or shorter.

Alternatively, heating treatment may be performed using a drying furnace or the like. In the case of using a drying furnace, for example, heat treatment at a temperature of 30° C. or higher and 120° C. or lower for 30 seconds or longer and 2 hours or shorter may be performed.

In addition, the temperature may be increased in stages. For example, after heat treatment is performed at 60° C. or lower for 10 minutes or shorter, heat treatment may further be performed at 65° C. or higher for 1 minute or longer.

Next, second heating is performed in Step S96. When polyimide is used as a binder, a cycloaddition reaction of polyimide is preferably caused by the second heating. In addition, a dehydration reaction of polyimide is caused by the second heating in some cases. Alternatively, a dehydration reaction is caused by the first heating in some cases. In the first heating, a cycloaddition reaction of polyimide may be caused. Moreover, a reduction reaction of the graphene compound is preferably caused by the second heating. Note that the second heating is sometimes referred to as imidizing heat treatment, reduction heat treatment, or thermal reduction treatment.

The second heating is preferably performed at a temperature in the range from 150° C. to 500° C. inclusive, further preferably from 200° C. to 450° C. inclusive.

As the second heating, heat treatment is performed at 200° C. or higher and 450° C. or lower for 1 hour or longer and 10 hours or shorter in a reduced-pressure environment of 10 Pa or lower or an inert gas atmosphere of nitrogen, argon, or the like.

In Step S97, an electrode provided with an active material layer over the current collector is obtained.

The thickness of the active material layer formed in this manner is preferably greater than or equal to 5 μm and less than or equal to 300 μm, further preferably greater than or equal to 10 μm and less than or equal to 150 μm, for example. The loading amount of the active material of the active material layer may be greater than or equal to 2 mg/cm² and less than or equal to 50 mg/cm², for example.

The active material layer may be formed on both surfaces of the current collector or on only one surface of the current collector. Alternatively, there may be regions of both surfaces where the active material layer is partly formed.

After the solvent is volatilized from the active material layer, pressing is preferably performed by a compression method such as a roll press method or a flat plate press method. In the pressing, heat may be applied.

### Example of Positive Electrode Active Material

Examples of a positive electrode active material include a lithium-containing composite oxide with an olivine crystal structure, a lithium-containing composite oxide with a layered rock-salt crystal structure, and a lithium-containing composite oxide with a spinel crystal structure.

As the positive electrode active material of one embodiment of the present invention, a positive electrode active material with a layered crystal structure is preferably used.

An example of a layered crystal structure is a layered rock-salt crystal structure. As a lithium-containing composite oxide with a layered rock-salt crystal structure, for example, it is possible to use a lithium-containing composite oxide represented by LiMₓO_{y} (x>0 and y>0, specifically y=2 and 0.8<x<1.2, for example). Here, M represents a metal element, which is preferably one or more selected from cobalt, manganese, nickel, and iron. Alternatively, M represents two or more selected from cobalt, manganese, nickel, iron, aluminum, titanium, zirconium, lanthanum, copper, and zinc, for example.

Examples of the lithium-containing composite oxide represented by LiMₓO_{y} include LiCoO₂, LiNiO₂, and LiMnO₂. Other examples of the lithium-containing composite oxide represented by LiMₓO_{y}, are a NiCo-based material represented by LiNiₓCo₁₋ₓO₂(0<x<1) and a NiMn-based material represented by LiNiₓMn₁₋ₓO₂(0<x<1).

As a lithium-containing composite oxide represented by LiMO₂, for example, a NiCoMn-based material (also referred to as NCM) represented by LiNiₓCo_{y}Mn_{z}O₂ (x>0, y>0, and 0.8<x+y+z<1.2) is given. Specifically, 0.1x<y<8x and 0.1.x<z<8x are preferably satisfied, for example. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof.

As a lithium-containing composite oxide with a layered rock-salt crystal structure, Li₂MnO₃ and Li₂MnO₃—LiMeO₂ (Me represents Co, Ni, or Mn) are given, for example.

With use of a positive electrode active material with a layered crystal structure typified by the above-described lithium-containing composite oxide, a secondary battery with a large amount of lithium per volume and high capacity per volume can be provided in some cases. In such a positive electrode active material, the amount of lithium extracted during charging per volume is large; thus, in order to perform stable charging and discharging, a crystal structure after the extraction needs to be stabilized. Break of the crystal structure in charging and discharging may hinder fast charging or fast discharging.

As a positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the performance of the secondary battery.

As the positive electrode active material, a lithium-manganese composite oxide that can be represented by a composition formula LiₐMn_{b}M_{c}O_{d} can be used. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0<a/(b+c)<2; c>0; and 0.26≤(b+c)/d<0.5. Note that the proportions of metals, silicon, phosphorus, and other elements in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain at least one element selected from chromium, cobalt, aluminum, nickel, iron, magnesium, molybdenum, zinc, indium, gallium, copper, titanium, niobium, silicon, phosphorus, and the like.

### Structure of Positive Electrode Active Material

A material with the layered rock-salt crystal structure, such as lithium cobalt oxide (LiCoO₂), is known to have a high discharge capacity and excel as a positive electrode active material of a secondary battery. As an example of the material with the layered rock-salt crystal structure, a composite oxide represented by LiMO₂ is given. The metal M contains a metal Me1. The metal Me1 is one or more kinds of metals containing cobalt. The metal M can contain a metal X in addition to the metal Me1. The metal X is one or more metals selected from magnesium, calcium, zirconium, lanthanum, barium, copper, potassium, sodium, and zinc.

It is known that the Jahn-Teller effect in a transition metal compound varies in degree according to the number of electrons in the d orbital of the transition metal.

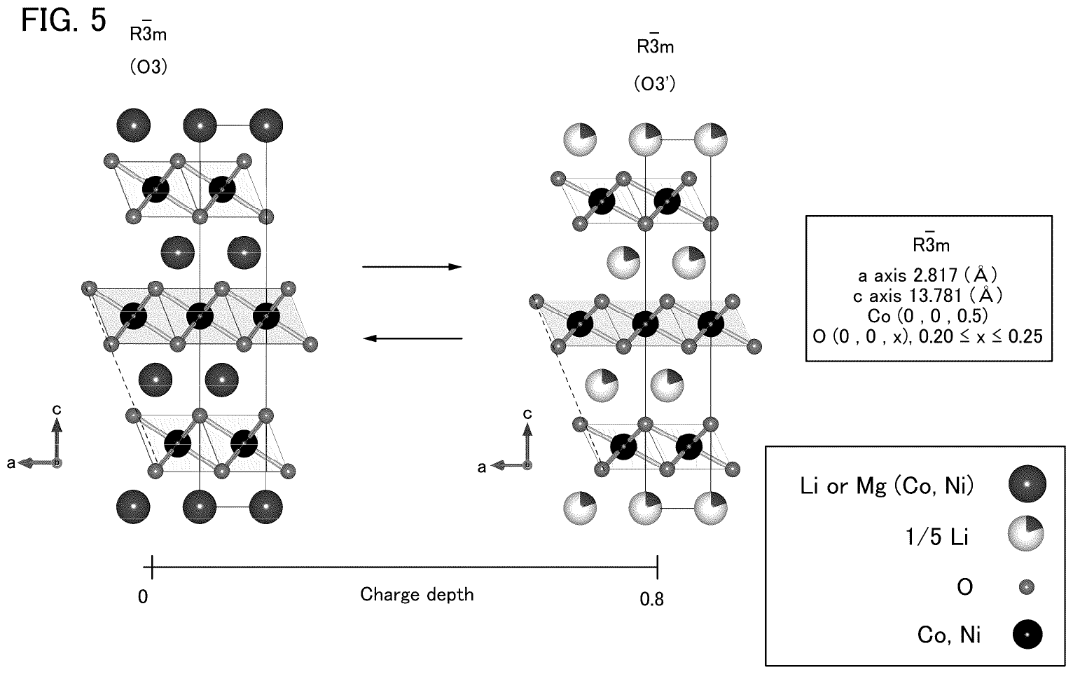

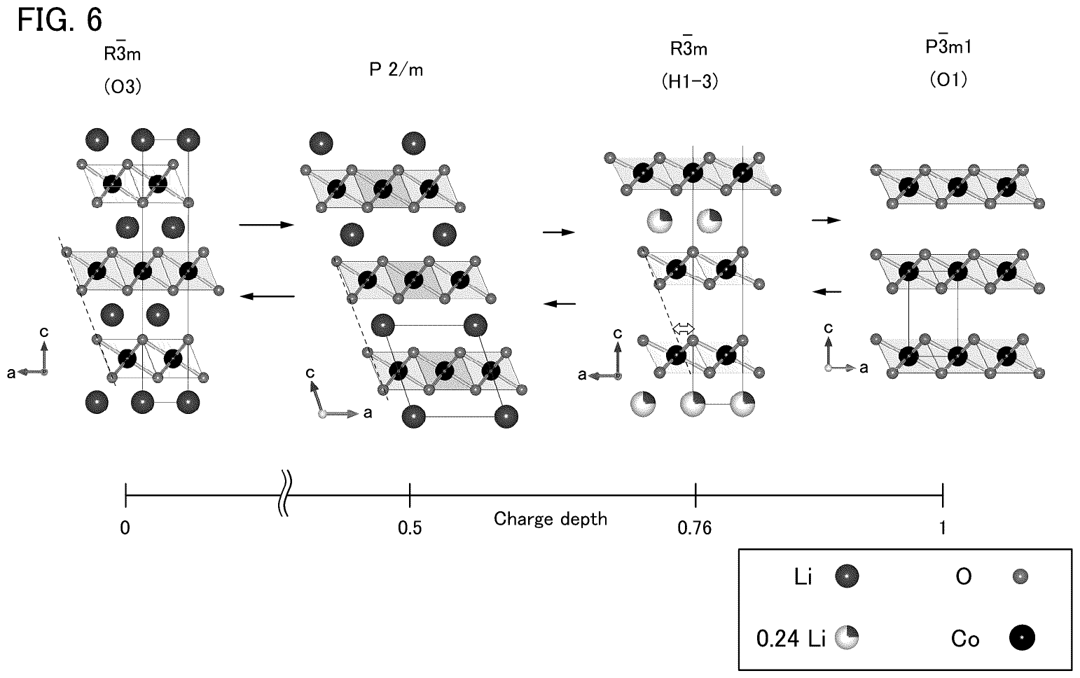

In a compound containing nickel, distortion is likely to be caused because of the Jahn-Teller effect in some cases. Accordingly, when charging and discharging at a high voltage are performed on LiNiO₂, the crystal structure might be broken because of the distortion. The influence of the Jahn-Teller effect is suggested to be small in LiCoO₂; hence, LiCoO₂ is preferable because the resistance to high-voltage charging is higher in some cases. The positive electrode active material will be described with reference to FIG. 5 and FIG. 6.

In the positive electrode active material fabricated according to one embodiment of the present invention, a deviation in the CoO₂ layers can be small in repeated charging and discharging at a high voltage. Furthermore, the change in the volume can be small. Thus, the compound can have excellent cycle performance. In addition, the compound can have a stable crystal structure in a high-voltage charged state. Thus, in the compound, sometimes a short circuit is less likely to occur while the high-voltage charged state is maintained. This is preferable because the safety is further improved.

The compound has a small change in the crystal structure and a small difference in volume per the same number of transition metal atoms between a sufficiently discharged state and a high-voltage charged state.

The positive electrode active material is preferably represented by a layered rock-salt crystal structure, and the region is represented by the space R-3m. The positive electrode active material is a region containing lithium, the metal Me1, oxygen, and the metal X. FIG. 5 illustrates examples of the crystal structures of the positive electrode active material before and after charging and discharging. The surface portion of the positive electrode active material may include a crystal containing titanium, magnesium, and oxygen and exhibiting a structure different from a layered rock-salt crystal structure in addition to or instead of the region exhibiting a layered rock-salt crystal structure described below with reference to FIG. 5 and the like. For example, a crystal containing titanium, magnesium, and oxygen and exhibiting a spinel structure may be included.

The crystal structure with a charge depth of 0 (discharged state) in FIG. 5 is R-3m (O3), which is the same as in FIG. 6. Meanwhile, the positive electrode active material illustrated in FIG. 5 with a charge depth (e.g., 0.8) in a sufficiently charged state includes a crystal whose structure is different from the H1-3 type crystal structure. This structure belongs to the space group R-3m and is not the spinel crystal structure, but has symmetry in cation arrangement similar to that of the spinel structure because an ion of cobalt, magnesium, or the like occupies a site coordinated to six oxygen atoms. Furthermore, the periodicity of CoO₂ layers of this structure is the same as that in the O3 type structure. This structure is thus referred to as the O3′ type crystal structure or the pseudo-spinel crystal structure in this specification and the like. Accordingly, the O3′ type crystal structure and the pseudo-spinel crystal structure may be rephrased as each other. Note that although the indication of lithium is omitted in the diagram of the pseudo-spinel crystal structure illustrated in FIG. 5 to explain the symmetry of cobalt atoms and the symmetry of oxygen atoms, lithium of 20 atomic % or less, for example, with respect to cobalt practically exists between the CoO₂ layers. In addition, in both the O3 type crystal structure and the pseudo-spinel crystal structure, a slight amount of magnesium preferably exists between the CoO₂ layers, i.e., in lithium sites. In addition, a slight amount of halogen such as fluorine may exist in oxygen sites at random.

Note that in the pseudo-spinel crystal structure, a light element such as lithium sometimes occupies a site coordinated to four oxygen atoms, the ion arrangement has symmetry similar to that of the spinel structure.

The pseudo-spinel crystal structure can also be regarded as a crystal structure that contains Li between layers at random but is similar to a CdCl₂ crystal structure. The crystal structure similar to the CdCl₂ crystal structure is close to a crystal structure of lithium nickel oxide (Li_{0.06}NiO₂) charged to a charge depth of 0.94; however, pure lithium cobalt oxide or a layered rock-salt positive electrode active material containing a large amount of cobalt is known not to have such a crystal structure generally.

Anions of a layered rock-salt crystal and anions of a rock-salt crystal have cubic closest packed structures (face-centered cubic lattice structures). Anions of a pseudo-spinel crystal are also presumed to have cubic closest packed structures. When the pseudo-spinel crystal is in contact with the layered rock-salt crystal and the rock-salt crystal, there is a crystal plane at which orientations of cubic closest packed structures composed of anions are aligned. Note that a space group of the layered rock-salt crystal and the pseudo-spinel crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the pseudo-spinel crystal is different from that in the rock-salt crystal. In this specification, a state where the orientations of the cubic close-packed structures composed of anions in the layered rock-salt crystal, the pseudo-spinel crystal, and the rock-salt crystal are aligned is sometimes referred to as a state where crystal orientations are substantially aligned.

In the positive electrode active material illustrated in FIG. 5, a change in the crystal structure when the positive electrode active material is charged at a high voltage and a large amount of lithium is extracted is inhibited as compared with a comparative example described later. As denoted by the dashed lines in FIG. 5, for example, the CoO₂ layers hardly shift between the crystal structures.

More specifically, the structure of the positive electrode active material illustrated in FIG. 5 is highly stable even when a charge voltage is high. For example, in a region of charge voltages that make the comparative example have the H1-3 type crystal structure, for example, at a voltage of approximately 4.6 V with reference to the potential of lithium metal, the crystal structure belonging to R-3m (O3) can be maintained. Moreover, in a higher charge voltage region, for example, at voltages of approximately 4.65 V to 4.7 V with reference to the potential of lithium metal, the pseudo-spinel crystal structure can be obtained. At a much higher charge voltage, a H1-3 type crystal is eventually observed in some cases. In the case where graphite, for instance, is used as a negative electrode active material in a secondary battery, a charge voltage region where the crystal structure belonging to R-3m (O3) can be maintained exists when the voltage of the secondary battery is, for example, higher than or equal to 4.3 V and lower than or equal to 4.5 V. In a higher charge voltage region, for example, at voltages higher than or equal to 4.35 V and lower than or equal to 4.55 V with reference to the potential of a lithium metal, there is a region within which the pseudo-spinel crystal structure can be obtained.

Thus, in the positive electrode active material illustrated in FIG. 5, the crystal structure is less likely to be broken even when charging and discharging are repeated at a high voltage.

Note that in the unit cell of the pseudo-spinel crystal structure, coordinates of cobalt and oxygen can be represented by Co (0, 0, 0.5) and O (0, 0, x) within the range of 0.20≤x≤0.25.

A slight amount of magnesium existing between the CoO₂ layers, i.e., in lithium sites at random, has an effect of inhibiting a deviation in the CoO₂ layers in high-voltage charging. Thus, the existence of magnesium between the CoO₂ layers makes it easier to obtain the pseudo-spinel crystal structure.

However, cation mixing occurs when the heat treatment temperature is excessively high; thus, magnesium is highly likely to enter cobalt sites. Magnesium in the cobalt sites does not have the effect of maintaining the R-3m structure in a high-voltage charged state.

Furthermore, heat treatment at an excessively high temperature might have an adverse effect; for example, cobalt might be reduced to have a valence of two or lithium might be evaporated or sublimated.

In view of the above, a halogen compound such as a fluorine compound is preferably added to lithium cobalt oxide before the heat treatment for distributing magnesium throughout the surface portion of the particle. The addition of the halogen compound decreases the melting point of the lithium cobalt oxide. The decreased melting point makes it easier to distribute magnesium throughout the surface portion of the particle at a temperature at which the cation mixing is unlikely to occur. Furthermore, it is expected that the existence of the fluorine compound can improve corrosion resistance to hydrofluoric acid generated by decomposition of an electrolyte.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material fabricated according to one embodiment of the present invention is preferably more than or equal to 0.001 times and less than or equal to 0.1 times, further preferably more than 0.01 times and less than 0.04 times, still further preferably approximately 0.02 times the number of cobalt atoms. The magnesium concentration described here may be a value obtained by element analysis on the whole particles of the positive electrode active material using ICP-MS or the like, or may be a value based on the ratio of the raw materials mixed in the process of fabricating the positive electrode active material, for example.

The number of nickel atoms in the positive electrode active material is preferably 7.5% or lower, preferably 0.05% or higher and 4% or lower, further preferably 0.1% or higher and 2% or lower the number of cobalt atoms. The nickel concentration described here may be a value obtained by element analysis on the whole particles of the positive electrode active material using ICP-MS or the like, or may be a value based on the ratio of the raw materials mixed in the process of fabricating the positive electrode active material, for example.

### Particle Diameter

Too large a particle diameter of the positive electrode active material causes problems such as difficulty in lithium diffusion and too much surface roughness of an active material layer in application on a current collector. By contrast, too small a particle diameter causes problems such as difficulty in loading of the active material layer in application on the current collector and overreaction with the electrolyte solution. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### Analysis Method

Whether or not a positive electrode active material is the positive electrode active material having the pseudo-spinel crystal structure (also referred to as O3′ structure) when charged at a high voltage can be determined by analyzing a high-voltage charged positive electrode using XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described so far, the positive electrode active material has a feature of a small change in the crystal structure between a high-voltage charged state and a discharged state. A material in which 50 wt % or more of the crystal structure largely changes between a high-voltage charged state and a discharged state is not preferable because the material cannot withstand charging and discharging at a high voltage. In addition, it should be noted that an objective crystal structure is not obtained in some cases only by addition of impurity elements. For example, although the positive electrode active material that is lithium cobalt oxide containing magnesium and fluorine is a commonality, the positive electrode active material has 60 wt % or more of the pseudo-spinel crystal structure in some cases, and has 50 wt % or more of the H1-3 type crystal structure in other cases, when charged at a high voltage. Furthermore, at a predetermined voltage, the positive electrode active material has almost 100 wt % of the pseudo-spinel crystal structure, and with an increase in the predetermined voltage, the H1-3 type crystal structure is generated in some cases. Thus, the crystal structure of the positive electrode active material is preferably analyzed by XRD or the like. The combination with XRD measurement or the like enables more detailed analysis.

However, the crystal structure of a positive electrode active material in a high-voltage charged state or a discharged state may be changed by exposure to the air. For example, the pseudo-spinel crystal structure changes into the H1-3 type crystal structure in some cases. Thus, all samples are preferably handled in an inert atmosphere such as an atmosphere containing argon.

A positive electrode active material illustrated in FIG. 6 is lithium cobalt oxide (LiCoO₂) to which the metal X is not added. The crystal structure of the lithium cobalt oxide illustrated in FIG. 6 is changed depending on a charge depth.

As illustrated in FIG. 6, in lithium cobalt oxide with a charge depth of 0 (discharged state), there is a region having a crystal structure belonging to the space group R-3m, and a unit cell includes three CoO₂ layers. Thus, this crystal structure is referred to as an O3 type crystal structure in some cases. Note that here, the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3m1 and includes one CoO₂ layer in a unit cell. Hence, this crystal structure is referred to as an O1 type crystal structure in some cases.

Lithium cobalt oxide with a charge depth of approximately 0.8 has the crystal structure belonging to the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 6, and other drawings, the c-axis of the H1-3 type crystal structure is half that of the unit cell for easy comparison with the other structures.

For the H1-3 type crystal structure, the coordinates of cobalt and oxygen in the unit cell can be expressed as follows, for example: Co (0, 0, 0.42150+0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell containing one cobalt and two oxygen. Meanwhile, the pseudo-spinel crystal structure of one embodiment of the present invention is preferably represented by a unit cell including one cobalt and one oxygen, as described later. This means that the symmetry of cobalt and oxygen differs between the pseudo-spinel structure and the H1-3 type structure, and the amount of change from the O3 structure is smaller in the pseudo-spinel structure than in the H1-3 type structure. A unit cell that should be used for representing a crystal structure in a positive electrode active material can be judged by the Rietveld analysis of XRD, for example. In this case, a unit cell is selected such that the value of GOF (goodness of fit) is small.

When charging at a high voltage of 4.6 V or higher based on the redox potential of a lithium metal or charging at a large charge depth of 0.8 or more and discharging are repeated, a change in the crystal structure of lithium cobalt oxide between the H1-3 type crystal structure and the R-3m (O3) structure in a discharged state (i.e., an unbalanced phase change) occurs repeatedly.

However, there is a large shift in the CoO₂ layers between these two crystal structures. As denoted by the dotted lines and the arrow in FIG. 6, the CoO₂ layer in the H1-3 type crystal structure largely shifts from that in R-3m (O3). Such a dynamic structural change can adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are arranged continuously, such as P-3m1 (O1), included in the H1-3 type crystal structure is highly likely to be unstable.

Thus, the repeated high-voltage charging and discharging breaks the crystal structure of lithium cobalt oxide. The broken crystal structure triggers degradation of the cycle performance. This is because the broken crystal structure has a smaller number of sites where lithium can exist stably and makes it difficult to insert and extract lithium.

### Electrolyte

In the case where a liquid electrolyte layer is used for a secondary battery, for example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used for the electrolyte layer, or two or more of them can be used in an appropriate combination at an appropriate ratio.

Alternatively, the use of one or more ionic liquids (room temperature molten salts) that are less likely to burn and volatize as the solvent of the electrolyte can prevent a secondary battery from exploding or catching fire even when the secondary battery internally shorts out or the temperature of the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention includes, as a carrier ion, any one or more of an alkali metal ion such as a sodium ion and a potassium ion and an alkaline earth metal ion such as a calcium ion, a strontium ion, a barium ion, a beryllium ion, and a magnesium ion, for example.

In the case where a lithium ion is used as a carrier ion, for example, an electrolyte contains lithium salt. As the lithium salt, for example, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiCAF₉SO₃, LiC(CF₃SO₂)₃, LiC(C₂F₅SO₂)₃, LiN(CF₃SO₂)₂, LiN(C₄F₉SO₂)(CF₃SO₂), or LiN(C₂F₅SO₂)₂ can be used.

The electrolyte preferably contains fluorine. As the electrolyte containing fluorine, for example, an electrolyte containing one kind or two or more kinds of fluorinated cyclic carbonates and lithium ions can be used. The fluorinated cyclic carbonate can improve nonflammability and increase the safety of the lithium-ion secondary battery.

As the fluorinated cyclic carbonate, ethylene fluoride carbonate such as monofluoroethylene carbonate (fluoroethylene carbonate, FEC, or F1EC), difluoroethylene carbonate (DFEC or F2EC), trifluoroethylene carbonate (F3EC), or tetrafluoroethylene carbonate (F4EC) can be used, for example. Note that DFEC includes an isomer such as cis-4,5 or trans-4,5. For operation at low temperatures, as the electrolyte, it is important to use one kind or two or more kinds of fluorinated cyclic carbonates to solvate a lithium ion and transport the lithium ion in the electrolyte included in the electrode in charging and discharging. When the fluorinated cyclic carbonate is not used as a small amount of additive but is contributed to transportation of a lithium ion in charging and discharging, operation can be performed at low temperatures. In the secondary battery, a group of approximately several to several tens of lithium ions moves.

The use of the fluorinated cyclic carbonate for the electrolyte can reduce desolvation energy that is necessary for a solvated lithium ion to enter an active material particle in the electrolyte included in an electrode. The reduction in the desolvation energy can facilitate insertion or extraction of a lithium ion into or from the active material particle even in a low-temperature range. Although a lithium ion sometimes moves remaining in a solvated state, a hopping phenomenon in which coordinated solvent molecules are interchanged occurs in some cases. When desolvation of a lithium ion becomes easy, movement owing to the hopping phenomenon is facilitated and the lithium ion may easily move. A decomposition product of the electrolyte generated by charging and discharging of the secondary battery clings to the surface of the active material, which might cause deterioration of the secondary battery. However, since the electrolyte containing fluorine is smooth, the decomposition product of the electrolyte is less likely to attach to the surface of the active material. Thus, the deterioration of the secondary battery can be inhibited.

In some cases, solvated lithium ions form a cluster in the electrolyte and the cluster moves in the negative electrode, between the positive electrode and the negative electrode, or in the positive electrode, for example.

An example of the fluorinated cyclic carbonate is shown below.

The monofluoroethylene carbonate (FEC) is represented by Formula (1) below.

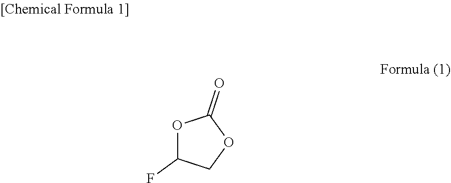

The tetrafluoroethylene carbonate (F4EC) is represented by Formula (2) below.

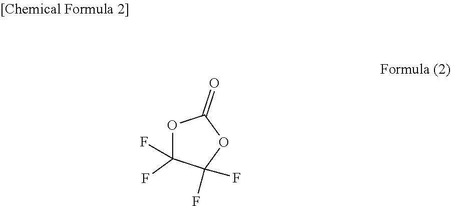

The difluoroethylene carbonate (DFEC) is represented by Formula (3) below.

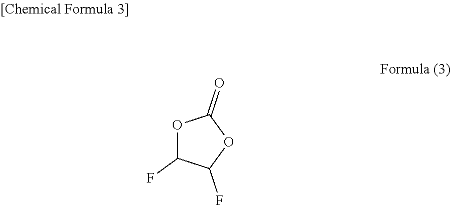

In this specification, an electrolyte is a general term of a solid electrolyte, a liquid electrolyte, a semi-solid-state gel electrolyte, and the like.

Deterioration is likely to occur at an interface existing in a secondary battery, e.g., an interface between an active material and an electrolyte. The secondary battery of one embodiment of the present invention includes the electrolyte containing fluorine, which can prevent deterioration that might occur at an interface between the active material and the electrolyte, typically, alteration of the electrolyte or a higher viscosity of the electrolyte. In addition, a structure may be employed in which a binder, a graphene compound, or the like clings to or is held by the electrolyte containing fluorine. This structure can maintain the state where the viscosity of the electrolyte is low, i.e., the state where the electrolyte is smooth, and can improve the reliability of the secondary battery. Note that DFEC to which two fluorine atoms are bonded and F4EC to which four fluorine atoms are bonded have lower viscosities, are smoother, and are coordinated to lithium more weakly than FEC to which one fluorine atom is bonded. Accordingly, it is possible to inhibit attachment of a decomposition product with a high viscosity to an active material particle. When a decomposition product with a high viscosity is attached to or clings to an active material particle, a lithium ion is less likely to move at an interface between active material particles. The solvating fluorine-containing electrolyte reduces generation of a decomposition product that is to be attached to the surface of the active material (the positive electrode active material or the negative electrode active material). Moreover, the use of the electrolyte containing fluorine prevents attachment of a decomposition product, which can prevent generation and growth of a dendrite.

The use of the electrolyte containing fluorine as a main component is also a feature, and the amount of the electrolyte containing fluorine is higher than or equal to 5 volume % or higher than or equal to 10 volume %, preferably higher than or equal to 30 volume % and lower than or equal to 100 volume %.

In this specification, a main component of an electrolyte occupies higher than or equal to 5 volume % of the whole electrolyte of a secondary battery. Here, “higher than or equal to 5 volume % of the whole electrolyte of a secondary battery” refers to the proportion in the whole electrolyte that is measured during manufacture of the secondary battery. In the case where a secondary battery is disassembled after manufactured, the proportions of a plurality of kinds of electrolytes are difficult to quantify, but it is possible to judge whether one kind of organic compound occupies higher than or equal to 5 volume % of the whole electrolyte.

With use of the electrolyte containing fluorine, it is possible to provide a secondary battery that can operate in a wide temperature range, specifically, higher than or equal to −40° C. and lower than or equal to 150° C., preferably higher than or equal to −40° C. and lower than or equal to 85° C.

An additive such as vinylene carbonate, propane sultone (PS), tert-butylbenzene (TBB), lithium bis(oxalate)borate (LiBOB), or a dinitrile compound such as succinonitrile or adiponitrile may be added to the electrolyte. The concentration of the additive agent in the whole electrolyte is, for example, higher than or equal to 0.1 volume % and lower than 5 volume %.

The electrolyte may contain one or more aprotic organic solvents such as γ-butyrolactone, acetonitrile, dimethoxyethane, and tetrahydrofuran, in addition to the above.

When a gelled high-molecular material is contained in the electrolyte, safety against liquid leakage and the like is improved. Typical examples of gelled high-molecular materials include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

Although the above structure is an example of a secondary battery using a liquid electrolyte, one embodiment of the present invention is not particularly limited thereto. For example, a semi-solid-state battery and an all-solid-state battery can be fabricated.

In this specification and the like, a layer provided between a positive electrode and a negative electrode is referred to as an electrolyte layer in both the case of a secondary battery using a liquid electrolyte and the case of a semi-solid-state battery. An electrolyte layer of a semi-solid-state battery is a layer formed by deposition, and can be distinguished from a liquid electrolyte layer.

In this specification and the like, a semi-solid-state battery refers to a battery in which at least one of an electrolyte layer, a positive electrode, and a negative electrode includes a semi-solid-state material. The semi-solid-state here does not mean that the proportion of a solid-state material is 50%. The semi-solid-state means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery. A semi-solid-state battery fabricated using the negative electrode of one embodiment of the present invention is a secondary battery having high charge and discharge capacity. The semi-solid-state battery can have high charge and discharge voltages. In addition, a highly safe or reliable semi-solid-state battery can be achieved.

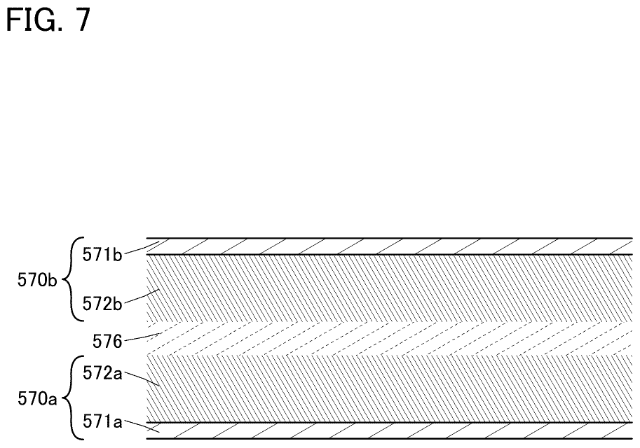

Here, an example of fabricating a semi-solid-state battery will be described with reference to FIG. 7.

FIG. 7 is a schematic cross-sectional view of a secondary battery of one embodiment of the present invention. The secondary battery of one embodiment of the present invention includes a negative electrode 570a and a positive electrode 570b. The negative electrode 570a includes at least a negative electrode current collector 571a and a negative electrode active material layer 572a formed in contact with the negative electrode current collector 571a, and the positive electrode 570b includes at least a positive electrode current collector 571b and a positive electrode active material layer 572b formed in contact with the positive electrode current collector 571b. The secondary battery includes an electrolyte 576 between the negative electrode 570a and the positive electrode 570b.

The electrolyte 576 contains a lithium-ion conductive polymer and a lithium salt.

In this specification and the like, the lithium-ion conductive polymer refers to a polymer having conductivity of cations such as lithium. More specifically, the lithium-ion conductive polymer is a high molecular compound containing a polar group to which cations can be coordinated. As the polar group, an ether group, an ester group, a nitrile group, a carbonyl group, siloxane, or the like is preferably included.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure. Alternatively, the lithium-ion conductive polymer may be a copolymer. The molecular weight is preferably greater than or equal to ten thousand, further preferably greater than or equal to hundred thousand, for example.

In the lithium-ion conductive polymer, lithium ions move by changing polar groups to interact with, due to the local motion (also referred to as segmental motion) of polymer chains. In PEO, for example, lithium ions move by changing oxygen to interact with, due to the segmental motion of ether chains. When the temperature is close to or higher than the melting point or softening point of the lithium-ion conductive polymer, the crystal regions melt to increase amorphous regions, so that the motion of the ether chains becomes active and the ion conductivity increases. Thus, in the case where PEO is used as the lithium-ion conductive polymer, charging and discharging are preferably performed at higher than or equal to 60° C.

According to the ionic radius of Shannon (Shannon et al., Acta A 32 (1976) 751.), the radius of a monovalent lithium ion is 0.590 Å in the case of tetracoordination, 0.76 Å in the case of hexacoordination, and 0.92 Å in the case of octacoordination. The radius of a bivalent oxygen ion is 1.35 Å in the case of bicoordination, 1.36 Å in the case of tricoordination, 1.38 Å in the case of tetracorrdination, 1.40 Å in the case of hexacoordination, and 1.42 Å in the case of octacoordination. The distance between polar groups included in adjacent lithium-ion conductive polymer chains is preferably greater than or equal to the distance that allows lithium ions and anion ions contained in the polar groups to exist stably while the above ionic radius is maintained. Furthermore, the distance between the polar groups is preferably a distance that causes sufficient interaction between the lithium ions and the polar groups. Note that the distance is not necessarily always kept constant because the segmental motion occurs as described above. It is acceptable to obtain an appropriate distance for the passage of lithium ions.

As the lithium salt, for example, it is possible to use a compound containing lithium and at least one of phosphorus, fluorine, nitrogen, sulfur, oxygen, chlorine, arsenic, boron, aluminum, bromine, and iodine. For example, one of lithium salts such as LiPF₆, LiN(FSO₂)₂(lithium bis(fluorosulfonyl)imide, LiFSI), LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄FOSO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (LiBOB) can be used, or two or more of these lithium salts can be used in an appropriate combination at an appropriate ratio.

It is particularly preferable to use LiFSI because favorable characteristics at low temperatures can be obtained. Note that LiFSI and LiTFSA are less likely to react with water than LiPF₆ or the like. This can relax the dew point control in fabricating an electrode and an electrolyte layer that use LiFSI. For example, the fabrication can be performed even in a normal air atmosphere, not only in an inert atmosphere of argon or the like in which moisture is excluded as much as possible or in a dry room in which a dew point is controlled. This is preferable because the productivity can be improved. When the segmental motion of ether chains is used for lithium conduction, it is particularly preferable to use a lithium salt that is highly dissociable and has a plasticizing effect, such as LiFSI and LiTFSA, in which case the operating temperature range can be wide.

In this specification and the like, a binder refers to a high molecular compound mixed only for binding an active material, a conductive material, and the like onto a current collector. A binder refers to, for example, a rubber material such as poly vinylidene difluoride (PVDF), styrene-butadiene rubber (SBR), styrene-isoprene-styrene rubber, butadiene rubber, or ethylene-propylene-diene copolymer; or a material such as fluorine rubber, polystyrene, polyvinyl chloride, polytetrafluoroethylene, polyethylene, polypropylene, polyisobutylene, or an ethylene-propylene-diene polymer.

Since the lithium-ion conductive polymer is a high molecular compound, the active material and the conductive material can be bound onto the current collector when the lithium-ion conductive polymer is sufficiently mixed in the active material layer. Thus, the electrode can be fabricated without a binder. A binder is a material that does not contribute to charge and discharge reactions. Thus, a smaller number of binders enable higher proportion of materials that contribute to charging and discharging, such as an active material and an electrolyte. As a result, the secondary battery can have higher discharge capacity, improved cycle performance, or the like.

When containing no or extremely little organic solvent, the secondary battery can be less likely to catch fire and ignite and thus can have higher level of safety, which is preferable. When an electrolyte layer 576 is an electrolyte layer containing no or extremely little organic solvent, the electrolyte layer can have enough strength and thus can electrically insulate the positive electrode from the negative electrode without a separator. Since a separator is not necessary, the secondary battery can have high productivity. When the electrolyte 576 is an electrolyte layer containing an inorganic filler, the secondary battery can have higher strength and higher level of safety.

The electrolyte layer is preferably dried sufficiently so that the electrolyte 576 can be an electrolyte layer containing no or extremely little organic solvent. In this specification and the like, the electrolyte layer can be regarded as being dried sufficiently when a change in the weight after drying at 90° C. under reduced pressure for one hour is within 5%.

Note that materials contained in a secondary battery, such as a lithium-ion conductive polymer, a lithium salt, a binder, and an additive agent can be identified using nuclear magnetic resonance (NMR), for example. Analysis results of Raman spectroscopy, Fourier transform infrared spectroscopy (FT-IR), time-of-flight secondary ion mass spectrometry (TOF-SIMS), gas chromatography mass spectroscopy (GC/MS), pyrolysis gas chromatography mass spectroscopy (Py-GC/MS), liquid chromatography mass spectroscopy (LC/MS), or the like can also be used for the identification. Note that analysis by NMR or the like is preferably performed after the active material layer is subjected to suspension using a solvent to separate the active material from the other materials.

Moreover, in each of the above structures, a solid electrolyte material may be further contained in the negative electrode to increase incombustibility. As the solid electrolyte material, an oxide-based solid electrolyte is preferably used.

Examples of the oxide-based solid electrolyte include lithium composite oxides and lithium oxide materials such as LiPON, Li₂O, Li₂CO₃, Li₂MoO₄, Li₃PO₄, Li₃VO₄, Li₄SiO₄, LLT(La_{2/3-x}Li₃ₓTiO₃), and LLZ(Li₇La₃Zr₂O₁₂).

LLZ is a garnet-type oxide containing Li, La, and Zr and may be a compound containing Al, Ga, or Ta.

Alternatively, a polymer solid electrolyte such as PEO (polyethylene oxide) formed by an application method or the like may be used. Such a polymer solid electrolyte can also function as a binder; thus, in the case of using a polymer solid electrolyte, the number of components of the electrode can be reduced and the manufacturing cost can also be reduced.

This embodiment can be used in appropriate combination with any of the other embodiments.

### Embodiment 2

In this embodiment, examples of a secondary battery of one embodiment of the present invention are described.

### Structure Example of Secondary Battery

Hereinafter, a secondary battery in which a positive electrode, a negative electrode, and an electrolyte solution are wrapped in an exterior body is described as an example.

### Negative Electrode

The negative electrode described in the above embodiment can be used as the negative electrode.

### Current Collector

For each of a positive electrode current collector and a negative electrode current collector, it is possible to use a material which has high conductivity and is not alloyed with carrier ions such as lithium, e.g., a metal such as stainless steel, gold, platinum, zinc, iron, copper, aluminum, or titanium, an alloy thereof, or the like. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a sheet-like shape, a net-like shape, a punching-metal shape, an expanded-metal shape, or the like as appropriate. The current collector preferably has a thickness greater than or equal to 10 μm and less than or equal to 30 μm.

Note that a material that is not alloyed with carrier ions such as lithium is preferably used for the negative electrode current collector.

As the current collector, a titanium compound may be stacked over the above-described metal element. As a titanium compound, for example, it is possible to use one selected from titanium nitride, titanium oxide, titanium nitride in which part of nitrogen is substituted by oxygen, titanium oxide in which part of oxygen is substituted by nitrogen, and titanium oxynitride (TiOₓN_{y}, where 0<x<2 and 0<y<1), or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and the graphene oxide.

### Positive Electrode

The positive electrode includes a positive electrode active material layer and the positive electrode current collector. The positive electrode active material layer includes a positive electrode active material, and may include a conductive material and a binder. As the positive electrode active material, the positive electrode active material described in the above embodiment can be used.

For the conductive material and the binder that can be included in the positive electrode active material layer, materials similar to those of the conductive material and the binder that can be included in the negative electrode active material layer can be used.

### Separator

A separator is positioned between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator is a porous material having a pore with a diameter of approximately 20 nm, preferably a pore with a diameter of greater than or equal to 6.5 nm, further preferably a pore with a diameter of at least 2 nm. In the case of the above-described semi-solid-state secondary battery, the separator can be omitted.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be inhibited and thus the reliability of the secondary battery can be improved. When the separator is coated with the fluorine-based material, the separator is easily in close contact with an electrode, resulting in high output characteristics. When the separator is coated with the polyamide-based material, especially, aramid, the safety of the secondary battery can be improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With use of a separator having a multilayer structure, the capacity per volume of the secondary battery can be increased because the safety of the secondary battery can be maintained even when the total thickness of the separator is small.

### Exterior Body

For an exterior body included in the secondary battery, a metal material such as aluminum and a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. As the film, a fluorine resin film is preferably used. The fluorine resin film has high stability to acid, alkali, an organic solvent, and the like and suppresses a side reaction, corrosion, or the like caused by a reaction of a secondary battery or the like, whereby an excellent secondary battery can be provided. Examples of the fluorine resin film include PTFE (polytetrafluoroethylene), PFA (perfluoroalkoxy alkane: a copolymer of tetrafluoroethylene and perfluoroalkyl vinyl ether), FEP (a perfluoroethylene-propene copolymer: a copolymer of tetrafluoroethylene and hexafluoropropylene), and ETFE (an ethylene-tetrafluoroethylene copolymer: a copolymer of tetrafluoroethylene and ethylene).

This embodiment can be implemented in appropriate combination with any of the other embodiments.

### Embodiment 3

This embodiment will describe examples of shapes of several types of secondary batteries including a positive electrode or a negative electrode fabricated by the fabrication method described in the above embodiment.

### Coin-Type Secondary Battery

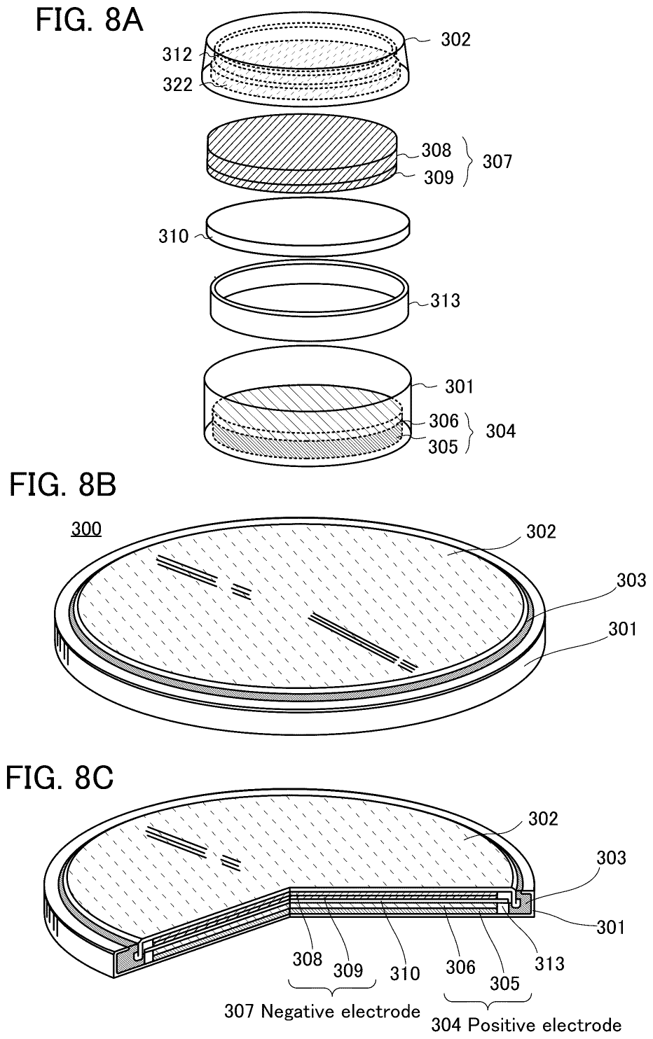

An example of a coin-type secondary battery is described. FIG. 8A is an exploded perspective view of a coin-type (single-layer flat type) secondary battery, FIG. 8B is an external view, and FIG. 8C is a cross-sectional view thereof. Coin-type secondary batteries are mainly used in small electronic devices.

For easy understanding, FIG. 8A is a schematic view illustrating overlap (a vertical relation and a positional relation) between components. Thus, FIG. 8A and FIG. 8B do not completely correspond with each other.

In FIG. 8A, a positive electrode 304, a separator 310, a negative electrode 307, a spacer 322, and a washer 312 are overlaid. These components are sealed with a negative electrode can 302 and a positive electrode can 301. Note that a gasket for sealing is not illustrated in FIG. 8A. The spacer 322 and the washer 312 are used to protect the inside or fix the position inside the cans at the time when the positive electrode can 301 and the negative electrode can 302 are bonded with pressure. For each of the spacer 322 and the washer 312, stainless steel or an insulating material is used.

The positive electrode 304 has a stack structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 8B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 may be provided with an active material layer.

For the positive electrode can 301 and the negative electrode can 302, a metal such as nickel, aluminum, or titanium having corrosion resistance to an electrolyte, an alloy thereof, or an alloy of such a metal and another metal (e.g., stainless steel) can be used. The positive electrode can 301 and the negative electrode can 302 are preferably covered with nickel, aluminum, or the like in order to prevent corrosion due to the electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte; as illustrated in FIG. 8C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The secondary battery can be the coin-type secondary battery 300 having high capacity, high charge and discharge capacity, and excellent cycle performance.

### Cylindrical Secondary Battery

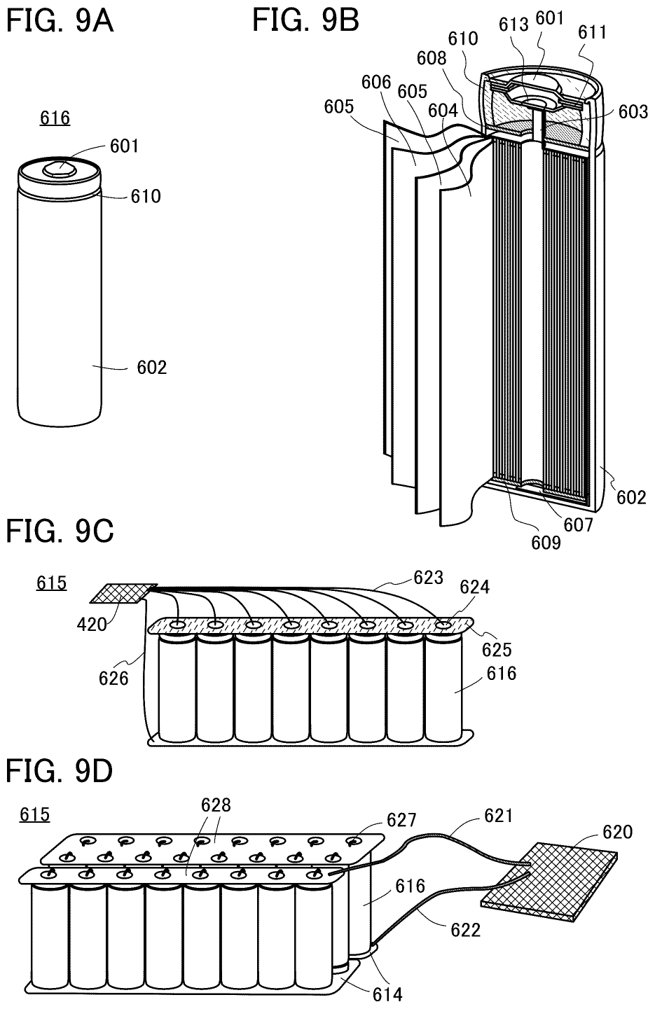

An example of a cylindrical secondary battery is described with reference to FIG. 9A. As illustrated in FIG. 9A, a cylindrical secondary battery 616 includes a positive electrode cap (battery cap) 601 on the top surface and a battery can (outer can) 602 on the side surface and bottom surface. The battery can (outer can) 602 is formed of a metal material and has an excellent barrier property against water permeation and an excellent gas barrier property. The positive electrode cap 601 and the battery can (outer can) 602 are insulated from each other by a gasket (insulating gasket) 610.

FIG. 9B schematically illustrates a cross section of a cylindrical secondary battery. The cylindrical secondary battery illustrated in FIG. 9B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal such as nickel, aluminum, or titanium having corrosion resistance to an electrolyte, an alloy thereof, or an alloy of such a metal and another metal (e.g., stainless steel) can be used. The battery can 602 is preferably covered with nickel, aluminum, or the like in order to prevent corrosion due to the electrolyte. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte (not illustrated). An electrolyte similar to that for the coin-type secondary battery can be used.

Since a positive electrode and a negative electrode that are used for a cylindrical storage battery are wound, active materials are preferably formed on both surfaces of a current collector.

The negative electrode obtained in Embodiment 1 is used, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. For both the positive electrode terminal 603 and the negative electrode terminal 607, a metal material such as aluminum can be used. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 9C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like and a protection circuit for preventing overcharging and/or overdischarging can be used.

FIG. 9D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in parallel and then be further connected in series.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 9D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### Other Structure Examples of Secondary Battery

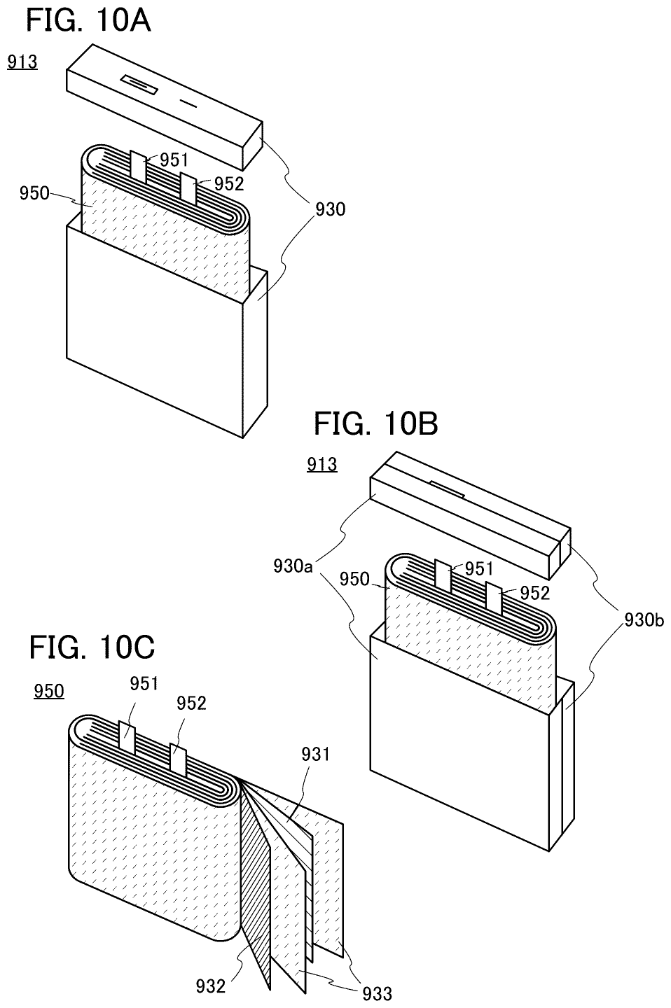

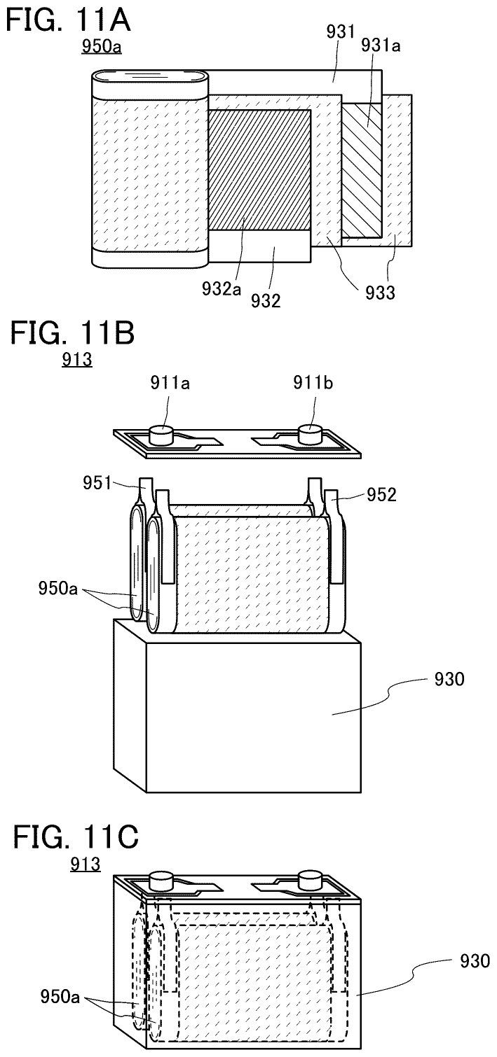

Structure examples of secondary batteries are described with reference to FIG. 10 and FIG. 11.

A secondary battery 913 illustrated in FIG. 10A includes a wound body 950 provided with a terminal 951 and a terminal 952 inside a housing 930. The wound body 950 is immersed in an electrolyte inside the housing 930. The terminal 952 is in contact with the housing 930. The terminal 951 is not in contact with the housing 930 with use of an insulator or the like. Note that in FIG. 10A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 10B, the housing 930 in FIG. 10A may be formed using a plurality of materials. For example, in the secondary battery 913 illustrated in FIG. 10B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 10C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be further stacked.

As illustrated in FIG. 11, the secondary battery 913 may include a wound body 950a. The wound body 950a illustrated in FIG. 11A includes the negative electrode 931, the positive electrode 932, and the separators 933. The negative electrode 931 includes a negative electrode active material layer 931a. The positive electrode 932 includes a positive electrode active material layer 932a.

An electrolyte containing fluorine is used for the negative electrode 931, whereby the secondary battery 913 can have high charge and discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 11A and FIG. 11B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 11C, the wound body 950a and an electrolyte are covered with the housing 930, whereby the secondary battery 913 is completed. The housing 930 is preferably provided with a safety valve, an overcurrent protection element, and the like. A safety valve is a valve to be released, in order to prevent the battery from exploding, when the pressure inside the housing 930 reaches a predetermined pressure.

As illustrated in FIG. 11B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 10A to FIG. 10C can be referred to for the other components of the secondary battery 913 illustrated in FIG. 11A and FIG. 11B.

### Laminated Secondary Battery

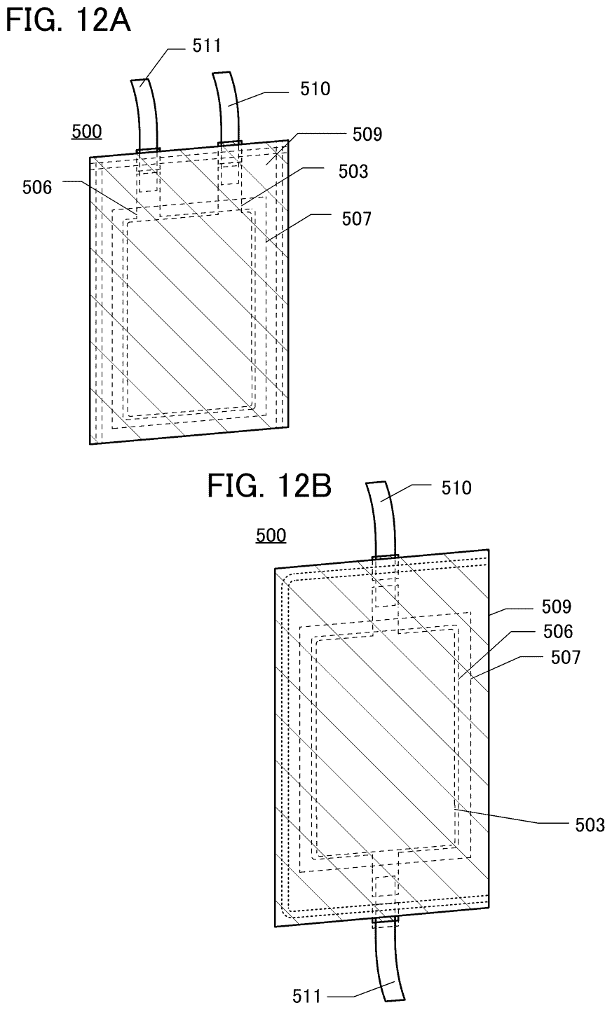

Next, examples of the appearance of a laminated secondary battery are illustrated in FIG. 12A and FIG. 12B. FIG. 12A and FIG. 12B each include a positive electrode 503, a negative electrode 506, a separator 507, an exterior body 509, a positive electrode lead electrode 510, and a negative electrode lead electrode 511.

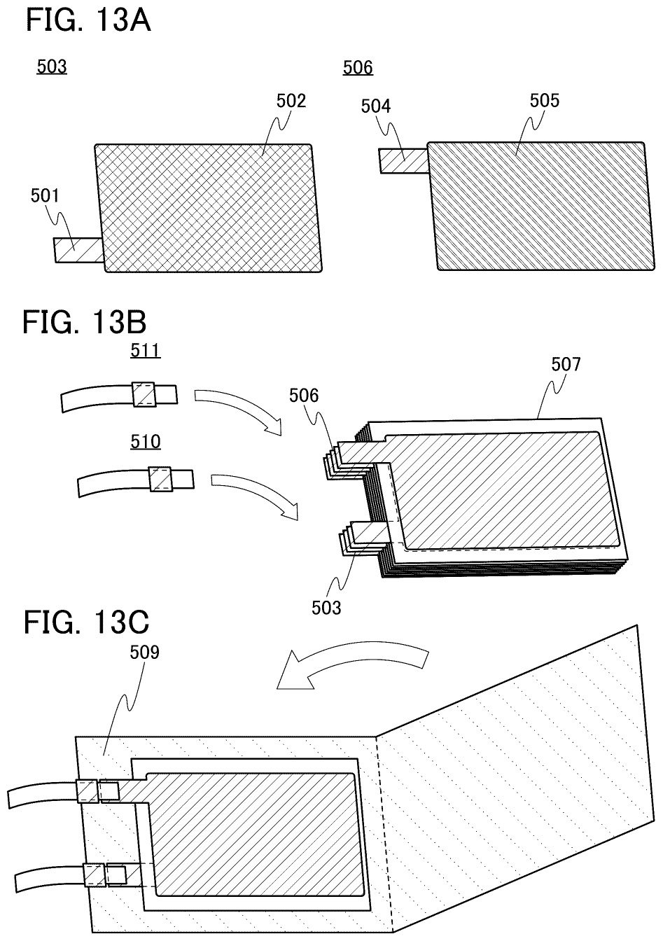

FIG. 13A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples shown in FIG. 13A.

### Method for Fabricating Laminated Secondary Battery

Here, an example of a method for fabricating the laminated secondary battery whose external view is illustrated in FIG. 12A will be described with reference to FIG. 13B and FIG. 13C.

First, the negative electrode 506, the separator 507, and the positive electrode 503 are stacked. FIG. 13B illustrates the negative electrodes 506, the separators 507, and the positive electrodes 503 that are stacked. Here, an example in which five negative electrodes and four positive electrodes are used is illustrated. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a portion shown by a dashed line, as illustrated in FIG. 13C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte 508 can be introduced later. As the exterior body 509, a film having an excellent barrier property against water permeation and an excellent gas barrier property is preferably used. The exterior body 509 having a stacked-layer structure including metal foil (for example, aluminum foil) as one of intermediate layers can have a high barrier property against water permeation and a high gas barrier property.

Next, the electrolyte 508 (not illustrated) is introduced into the exterior body 509 from the inlet of the exterior body 509. The electrolyte 508 is preferably introduced in a reduced-pressure atmosphere or in an inert atmosphere. Lastly, the inlet is sealed by bonding. In this manner, the laminated secondary battery 500 can be fabricated.

The negative electrode structure obtained in Embodiment 1, i.e., an electrode in which the graphene compound tightly clings to the material, which is obtained by mixing the particle containing silicon, the material containing halogen, and the material containing oxygen and carbon and then performing heating, is used for the negative electrode 506, whereby the secondary battery 500 can have high capacity, high charge and discharge capacity, and excellent cycle performance.

This embodiment can be implemented in appropriate combination with any of the other embodiments.

### Embodiment 4

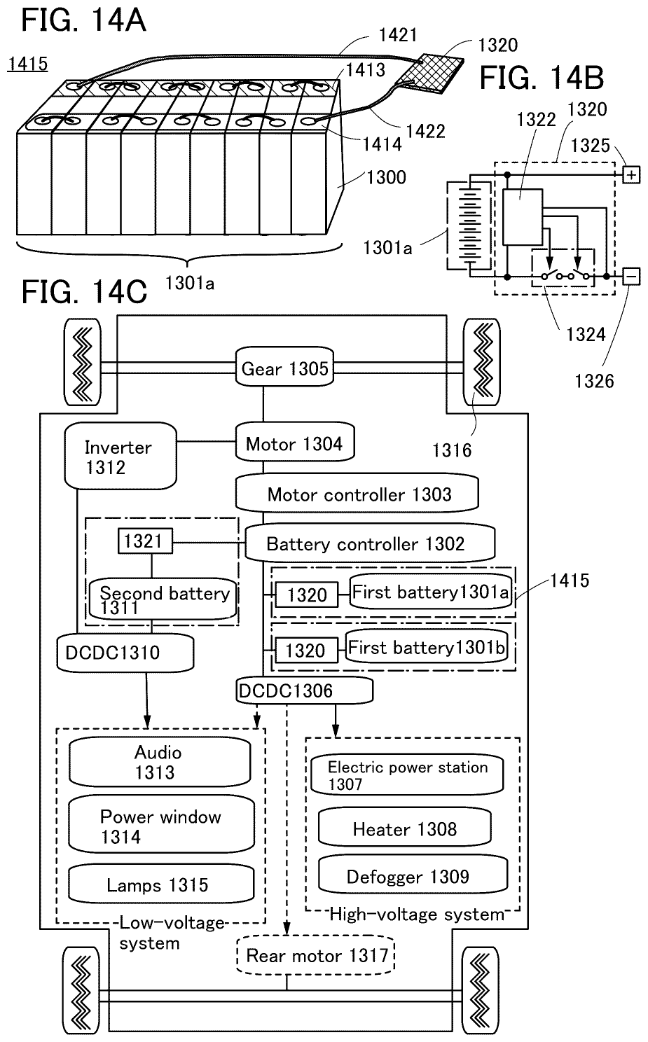

In this embodiment, an example different from the cylindrical secondary battery in FIG. 9D will be described. An example of application to an electric vehicle (EV) will be described with reference to FIG. 14C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 10A or the stacked structure illustrated in FIG. 12A and FIG. 12B.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off a high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a will be described with reference to FIG. 14A.

FIG. 14A illustrates an example in which nine rectangular secondary batteries 1300 constitute one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment illustrates the example in which the secondary batteries are fixed by the fixing portions 1413 and 1414, the secondary batteries may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 or a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharging, the control circuit portion 1320 can turn off both an output transistor of a charging circuit and an interruption switch substantially at the same time.

FIG. 14B illustrates an example of a block diagram of the battery pack 1415 illustrated in FIG. 14A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and have the upper limit of input current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage.

In this embodiment, an example in which a lithium-ion secondary battery is used as each of the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

Mounting the secondary battery illustrated in FIG. 9D or FIG. 14A on vehicles can provide next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft or rotary-wing aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and can be favorably used in transport vehicles.

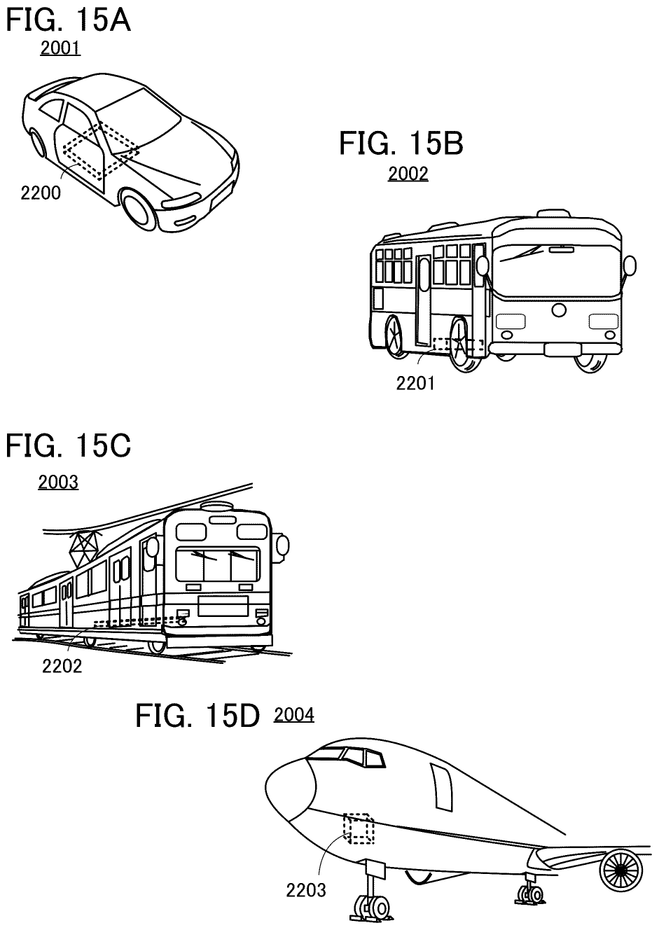

FIG. 15A to FIG. 15D illustrate examples of moving vehicles such as transport vehicles using one embodiment of the present invention. An automobile 2001 illustrated in FIG. 15A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, the secondary battery is provided at one position or several positions. The automobile 2001 illustrated in FIG. 15A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from external charging equipment through a plug-in system or a contactless charging system. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, a plug-in technique enables an exterior power supply to charge a storage battery incorporated in the automobile 2001. Charging can be performed by converting AC power into DC power through a converter such as an AC-DC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 15B illustrates a large transporter 2002 having a motor controlled by electric power, as an example of a transport vehicle. In the secondary battery module of the transporter 2002, a cell unit includes four secondary batteries with a voltage of 3.5 V or higher and 4.7 V or lower, and 48 cells are connected in series to have 170 V as the maximum voltage. A battery pack 2201 has a function similar to that in FIG. 15A except that the number of secondary batteries forming the secondary battery module of the battery pack 2201 or the like is different; thus the description is omitted.

FIG. 15C illustrates a large transport vehicle 2003 having a motor controlled by electricity as an example. In the secondary battery module of the transport vehicle 2003, 100 or more secondary batteries with a voltage of 3.5 V or higher and 4.7 V or lower are connected in series, and the maximum voltage is 600 V, for example. Thus, the secondary batteries are required to have few variations in the characteristics. With use of a secondary battery employing the structure including an electrolyte containing fluorine in a negative electrode, a secondary battery having stable battery characteristics can be manufactured and its high-volume production at low costs is possible in light of the yield. A battery pack 2202 has a function similar to that in FIG. 15A except that the number of secondary batteries forming the secondary battery module of the battery pack 2202 or the like is different; thus the detailed description is omitted.

FIG. 15D illustrates an aircraft 2004 having a combustion engine as an example. The aircraft 2004 illustrated in FIG. 15D can be regarded as a kind of a transport vehicle since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. A battery pack 2203 has a function similar to that in FIG. 15A except that the number of secondary batteries constituting the secondary battery module of the battery pack 2203 or the like is different; thus the detailed description is omitted.

This embodiment can be implemented in appropriate combination with any of the other embodiments.

### Embodiment 5

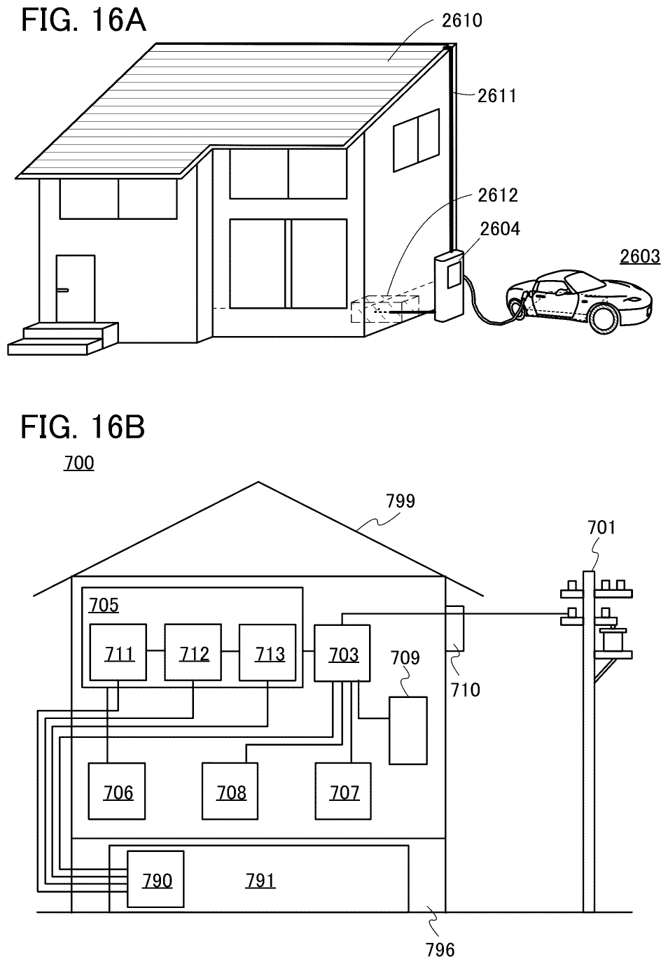

In this embodiment, examples in which the secondary battery of one embodiment of the present invention is mounted on a building will be described with reference to FIG. 16A and FIG. 16B.

A house illustrated in FIG. 16A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charging equipment 2604. The power storage device 2612 can be charged with electric power generated by the solar panel 2610. The secondary battery included in a vehicle 2603 can be charged with the electric power stored in the power storage device 2612 through the charge equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with use of the power storage device 2612 of one embodiment of the present invention as an uninterruptible power source, electronic devices can be used even when electric power cannot be supplied from a commercial power source due to power failure or the like.

FIG. 16B illustrates an example of a power storage device 700 of one embodiment of the present invention. As illustrated in FIG. 16B, a power storage device 791 of one embodiment of the present invention is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

This embodiment can be used in appropriate combination with any of the other embodiments.

### Embodiment 6

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

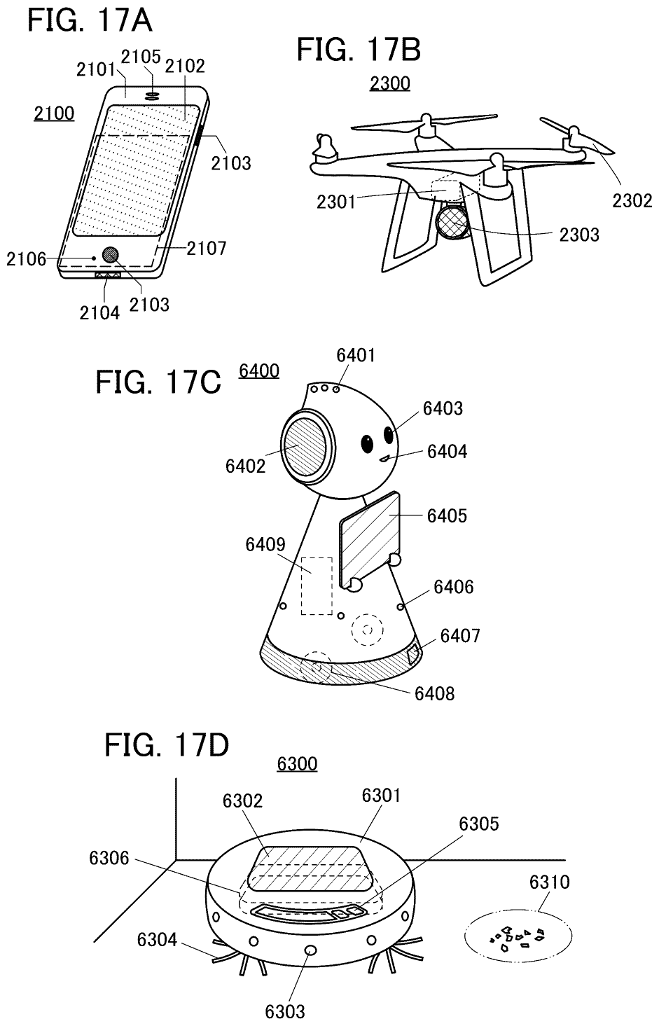

FIG. 17A illustrates an example of a mobile phone. A mobile phone 2100 includes a display portion 2102 set in a housing 2101, an operation button 2103, an external connection port 2104, a speaker 2105, a microphone 2106, and the like. The mobile phone 2100 includes a secondary battery 2107. The use of the secondary battery 2107 having the structure including an electrolyte containing fluorine in a negative electrode can achieve high capacity and a structure that accommodates space saving due to a reduction in size of the housing. The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by an operating system incorporated in the mobile phone 2100.

The mobile phone 2100 can employ near field communication based on a communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, and a temperature sensor, a touch sensor, a pressure sensitive sensor, an acceleration sensor, or the like is preferably mounted, for example.

FIG. 17B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery employing the structure including an electrolyte containing fluorine in a negative electrode has high energy density and a high degree of safety, and thus can be used safely for a long time over a long period of time and is suitable for the secondary battery used in the unmanned aircraft 2300.

FIG. 17C illustrates an example of a robot. A robot 6400 illustrated in FIG. 17C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user, using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery employing the structure including an electrolyte containing fluorine in a negative electrode has high energy density and a high degree of safety, and thus can be used safely for a long time over a long period of time and is suitable for the secondary battery 6409 included in the robot 6400.

FIG. 17D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, which is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery employing the structure including an electrolyte containing fluorine in a negative electrode has high energy density and a high degree of safety, and thus can be used safely for a long time over a long period of time and is suitable for the secondary battery 6306 included in the cleaning robot 6300.

This embodiment can be implemented in appropriate combination with the other embodiments.

### Notes on Description of This Specification and the Like

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing a minus sign (−) at the front of a number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like is preferably a region that is less than or equal to 50 nm, preferably less than or equal to 35 nm, further preferably less than or equal to 20 nm from the surface, for example. A plane generated by a split and a crack may also be referred to as a surface. In addition, a region in a deeper position than a surface portion is referred to as an inner portion.

In this specification and the like, the layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, a pseudo-spinel crystal structure of a composite oxide containing lithium and a transition metal belongs to the space group R-3m, and is not a spinel crystal structure but a crystal structure in which an ion of cobalt, magnesium, or the like is coordinated to six oxygen atoms and the cation arrangement has symmetry similar to that of the spinel crystal structure.

Substantial alignment of the crystal orientations in two regions can be judged from a TEM (transmission electron microscopy) image, a STEM (scanning transmission electron microscopy) image, a HAADF-STEM (high-angle annular dark-field scanning transmission electron microscopy) image, an ABF-STEM (annular bright-field scanning transmission electron microscopy) image, or the like. X-ray diffraction (XRD), electron diffraction, neutron diffraction, and the like can also be used for judging. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, a light element typified by oxygen or fluorine cannot be clearly observed in some cases; in such a case, alignment of orientations can be judged by arrangement of metal elements.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the depth of charge obtained when all the lithium that can be inserted and extracted is inserted is 0, and the depth of charge obtained when all the lithium that can be inserted and extracted in a positive electrode active material is extracted is 1.

In this specification and the like, charging refers to transfer of lithium ions from a positive electrode to a negative electrode in a battery and transfer of electrons from a positive electrode to a negative electrode in an external circuit. For a positive electrode active material, extraction of lithium ions is called charging. A positive electrode active material with a charge depth of greater than or equal to 0.7 and less than or equal to 0.9 may be referred to as a positive electrode active material charged at a high voltage.

Similarly, discharging refers to transfer of lithium ions from a negative electrode to a positive electrode in a battery and transfer of electrons from a negative electrode to a positive electrode in an external circuit. For a positive electrode active material, insertion of lithium ions is called discharging. Furthermore, a positive electrode active material with a charge depth of 0.06 or less or a positive electrode active material from which 90% or more of the charge capacity in a high-voltage charged state is discharged is referred to as a sufficiently discharged positive electrode active material.

In this specification and the like, an unbalanced phase change refers to a phenomenon that causes a nonlinear change in physical quantity. For example, an unbalanced phase change is presumed to occur around a peak in a dQ/dV curve obtained by differentiating capacitance (Q) with a voltage (V) (dQ/dV), resulting in a large change in the crystal structure.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity. As the material forming the negative electrode, a negative electrode active material is given. The negative electrode active material is, for example, a substance performing reaction that contributes to the charge and discharge capacity. Note that the negative electrode active material may partly contain a substance that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In this specification and the like, the negative electrode active material of one embodiment of the present invention is expressed as a negative electrode material, a secondary battery negative electrode material, or the like in some cases. In this specification and the like, the negative electrode active material of one embodiment of the present invention preferably contains a compound. In this specification and the like, the negative electrode active material of one embodiment of the present invention preferably contains a composition. In this specification and the like, the negative electrode active material of one embodiment of the present invention preferably contains a composite.

The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

Constant current charging refers to a charging method with a fixed charge rate, for example. Constant voltage charging refers to a charging method in which a voltage is fixed when reaching the upper voltage limit, for example. Constant current discharging refers to a discharging method with a fixed discharge rate, for example.

### EXAMPLE

In this example, negative electrodes of one embodiment of the present invention were fabricated and the fabricated negative electrodes were evaluated.

### Fabrication of Negative Electrode

The negative electrodes were fabricated according to the flowchart shown in FIG. 4. As the particle containing silicon, a nanosilicon particle manufactured by ALDRICH was used. As the particle containing graphite, a spherical graphite particle CGB-15 manufactured by Nippon Graphite Industries, Co. Ltd. was used. As the graphene compound, graphene oxide was used. As the polyimide, a precursor of polyimide manufactured by Toray Industries, Inc. was used.

As the negative electrodes, an electrode GS1, an electrode GS2, an electrode GS3, and an electrode GS4 were fabricated. The electrode GS1 to the electrode GS4 were fabricated in the same manner except for the electrode compounding ratio shown in Table 1. Note that the electrode compounding ratio shown in Table 1 is a weight ratio of the materials prepared in Steps S61, S72, S80, and S87 in FIG. 4 in fabrication of the electrode GS1 to the electrode GS4. The following shows the details.

TABLE 1

| | Electrode compounding ratio | | | |
|---|---|---|---|---|
| Electrode | | | Graphene | Precursor of |
| No. | Graphite | Nanosilicon | oxide | polyimide |
| GS1 | 76.8 | 19.2 | 1 | 3 |
| GS2 | 86.4 | 9.6 | 1 | 3 |
| GS3 | 64 | 16 | 5 | 15 |
| GS4 | 72 | 8 | 5 | 15 |

The nanosilicon particle and a solvent were prepared and mixed (Steps S61, S62, and S63 in FIG. 4). As the solvent, NMP was used. In the mixing, mixing was performed at 2000 rpm for three minutes with use of a planetary centrifugal mixer (Awatori rentaro produced by THINKY CORPORATION) and the mixture was collected to give the mixture E-1 (Steps S64 and S65 in FIG. 4).

Next, the spherical graphite particle was prepared and mixed with the mixture E-1 (Steps S72 and S73 in FIG. 4). In the mixing, mixing was performed at 2000 rpm for three minutes with use of a planetary centrifugal mixer (Awatori rentaro produced by THINKY CORPORATION) and the mixture was collected to give the mixture E-2 (Steps S74 and S75 in FIG. 4).

Next, the mixture E-2 and a graphene compound were mixed repeatedly with a solvent added thereto. Graphene oxide was prepared as the graphene compound, mixing was performed at 2000 rpm for three minutes with use of the planetary centrifugal mixer, and the mixture was collected (Steps S80, S81, and S82 in FIG. 4). Then, the collected mixture was stiff-kneaded and NMP was added thereto as appropriate, and mixing was performed at 2000 rpm for three minutes with use of the planetary centrifugal mixer and the mixture was collected (Steps S83, S84, and Step S85 in FIG. 4). Step S83 to Step S85 were repeated five times to give the mixture E-3 (Step S86 in FIG. 4).

Next, the mixture E-3 and the precursor of polyimide were mixed (Step S88 in FIG. 4). Mixing was performed at 2000 rpm for three minutes with use of the planetary centrifugal mixer. After that, NMP was prepared and added to the mixture so that the viscosity of the mixture was adjusted (Step S89 in FIG. 4), and further mixing was performed (twice at 2000 rpm for three minutes with use of the planetary centrifugal mixer), the mixture was collected, whereby the mixture E-4 was obtained as a slurry (Steps S90, S91, and S92 in FIG. 4).

Next, a current collector was prepared and was applied to the mixture E-4 (Steps S93 and S94 in FIG. 4). An undercoated copper foil was prepared as the current collector and the mixture E-4 was applied to the copper foil with use of a doctor blade with a gap thickness of 100 μm. The current collector used is the prepared copper foil having a thickness of copper of 18 μm and including a coating layer containing carbon as the undercoat. AB was used as a material in the coating layer containing carbon.

Then, the first heating was performed on the copper foil to which the mixture E-4 was applied at 50° C. for one hour (Step S95 in FIG. 4). After that, the second heating was performed under reduced pressure at 400° C. for five hours (Step S96 in FIG. 4), whereby an electrode was obtained. By the heating, the graphene oxide is reduced, so that the amount of oxygen is decreased.

### SEM

SEM observation of the surface of the fabricated electrode was performed. The SEM observation was performed at a timing after the first heating. As the SEM, SU8030 manufactured by Hitachi High-Tech Corporation was used. The accelerating voltage was 5 kV.

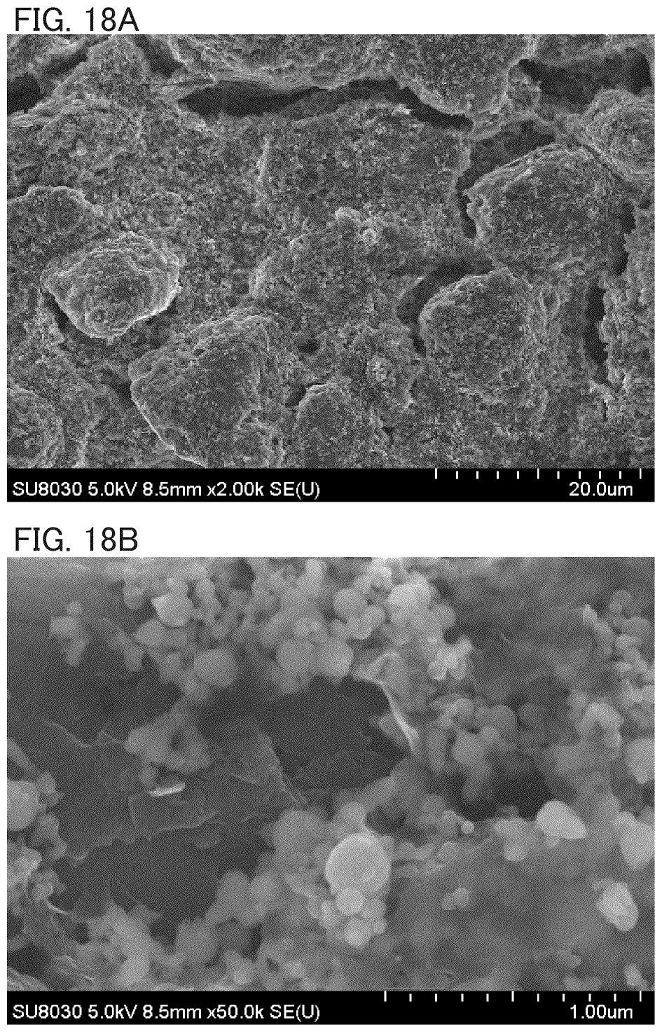

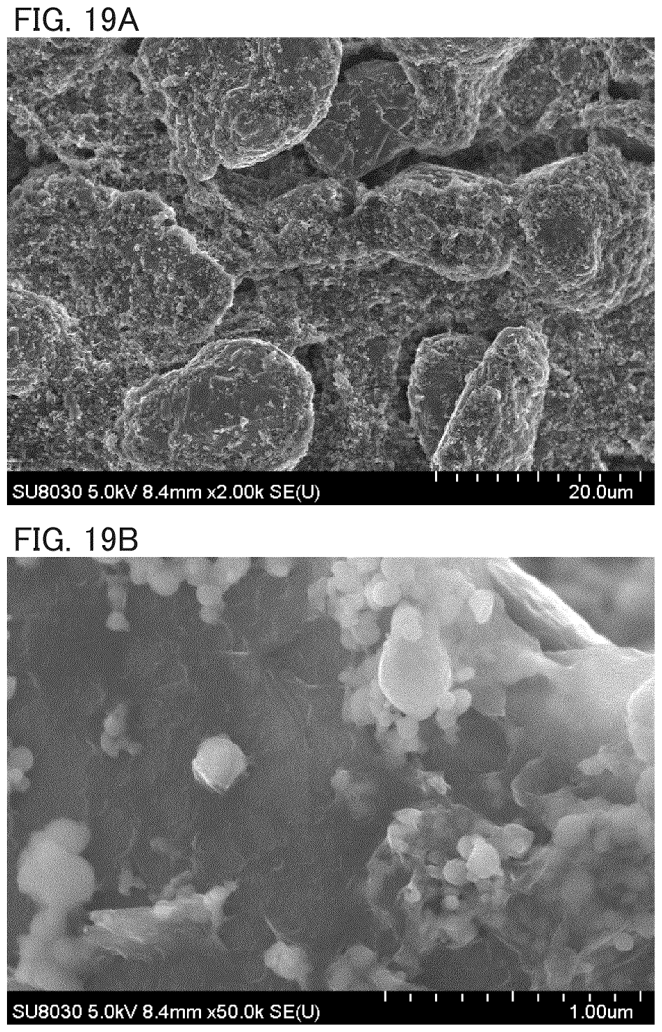

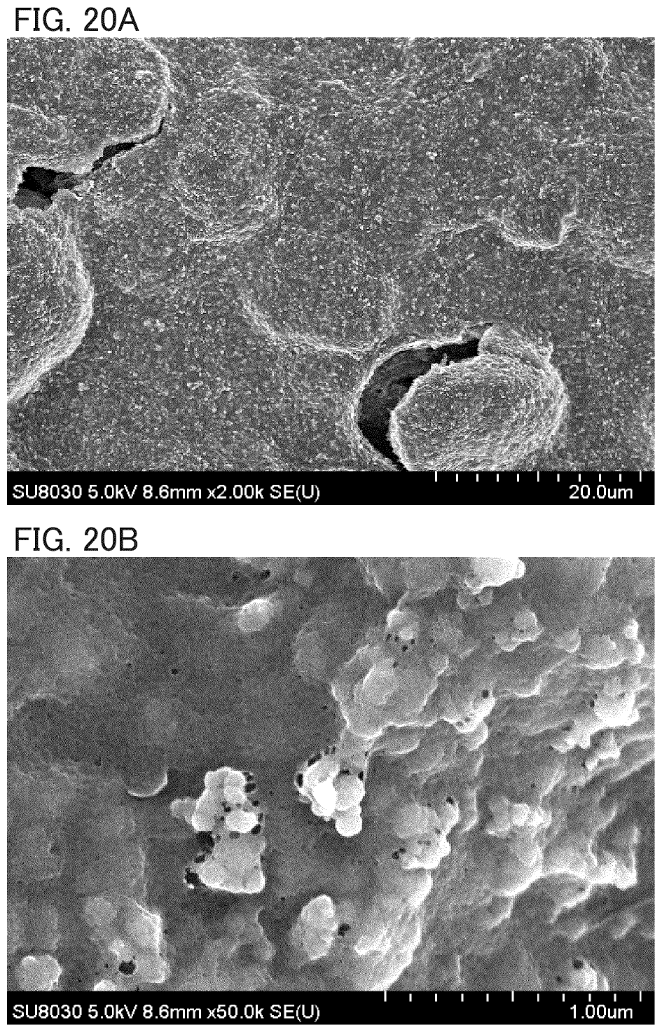

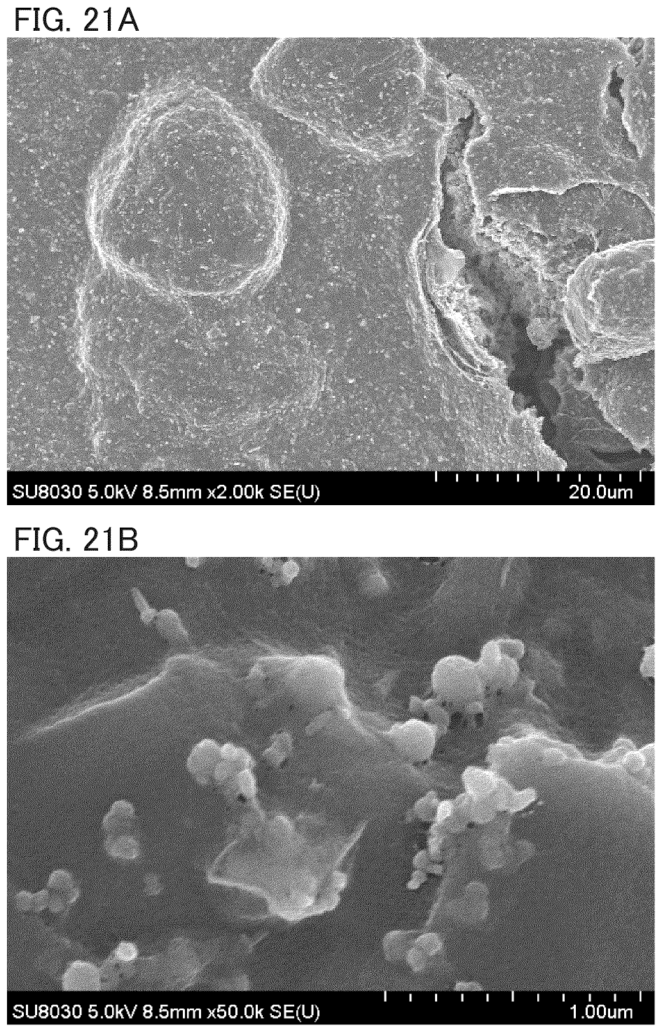

FIG. 18A and FIG. 18B are each an observation image of a surface of the electrode GS1. FIG. 19A and FIG. 19B are each an observation image of a surface of the electrode GS2. FIG. 20A and FIG. 20B are each an observation image of a surface of the electrode GS3. FIG. 21A and FIG. 21B are each an observation image of a surface of the electrode GS4. In the SEM images, the nanosilicon particles show relatively high contrast.

FIG. 18B is an enlarged image of the surface of a graphite particle with a particle diameter of approximately 10 μm or greater and 20 μm or less included in the electrode GS1. A nanosilicon particle with a particle diameter of approximately 50 nm or greater and 250 nm or less existed on the surface of the graphite particle, and a region covered with graphene oxide and a region not covered with graphene oxide were observed.

FIG. 19B is an enlarged image of the surface of a graphite particle with a particle diameter of approximately 10 μm or greater and 20 μm or less included in the electrode GS2. A nanosilicon particle with a particle diameter of approximately 50 nm or greater and 250 nm or less existed on the surface of the graphite particle, and a region covered with graphene oxide and a region not covered with graphene oxide were observed. GS2 tends to have more regions covered with graphene oxide than GS1.

FIG. 20B is an enlarged image of the surface of a graphite particle with a particle diameter of approximately 10 μm or greater and 20 μm or less included in the electrode GS3. A nanosilicon particle with a particle diameter of approximately 50 nm or greater and 250 nm or less existed on the surface of the graphite particle, and a region covered with graphene oxide and a region not covered with graphene oxide were observed. GS3 tends to have more regions covered with graphene oxide than GS2.

FIG. 21B is an enlarged image of the surface of a graphite particle with a particle diameter of approximately 10 μm or greater and 20 μm or less included in the electrode GS4. A nanosilicon particle with a particle diameter of approximately 50 nm or greater and 250 nm or less existed on the surface of the graphite particle, and a region covered with graphene oxide and a region not covered with graphene oxide were observed. GS4 tends to have further more regions covered with graphene oxide than GS3, and most nanosilicon particles are covered with a plurality of sheets of graphene oxide.

### Fabrication of Coin Cell

Next, using the fabricated electrode GS1 to electrode GS4, a CR2032 type coin cell (with a diameter of 20 mm and a height of 3.2 mm) was fabricated.

Lithium metal was used for a counter electrode. An electrolyte solution was used in which lithium hexafluorophosphate (LiPF₆) was mixed at a concentration of 1 mol/L into a mixture of ethylene carbonate (EC) and diethyl carbonate (DEC) with EC:DEC=3:7 (in volume ratio).

As a separator, a 25-μm-thick separator formed of polypropylene was used.

A positive electrode can and a negative electrode can that were formed using stainless steel (SUS) were used.

### Charge and Discharge Characteristics

The evaluation of charge and discharge characteristics was performed on the fabricated coin cell. In the fabricated coin cell, lithium is occluded in the electrode in discharging and lithium is released from the electrode in charging.

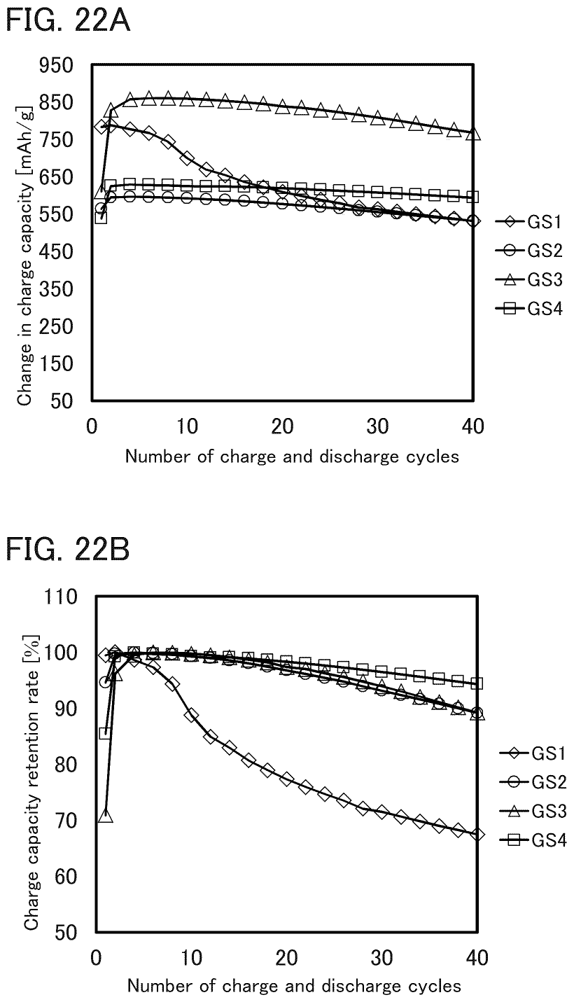

The discharge condition (lithium occlusion condition) was set to constant current discharging (0.1 C and lower voltage limit of 0.01 V) and then constant voltage discharging (lower current density of 0.01 C), and charging condition (lithium release) was set to constant current charging (0.1 C and upper voltage limit of 1 V). Discharging and charging were performed at 25° C. FIG. 22A and FIG. 22B show changes in capacity with respect to the cycle number in charge and discharge cycles. Table 2 shows the maximum charge capacity and the charge capacity retention rate after 40 cycles in the charge and discharge cycle test.

TABLE 2

| | Electrode | | Cycle test perfrmance | |
|---|---|---|---|---|
| | compounding ratio | | Maximum | Charge capacity |
| Electrode | Graphene | Silicon/ | charge | retention rate |
| No. | oxide/Silicon | Graphite | capacity | after 40 cycles |
| GS1 | 0.05 | 0.25 | 787.7 mAh/g | 67.49% |
| GS2 | 0.10 | 0.11 | 596.3 mAh/g | 89.15% |
| GS3 | 0.31 | 0.25 | 860.9 mAh/g | 89.20% |
| GS4 | 0.63 | 0.11 | 629.6 mAh/g | 94.34% |

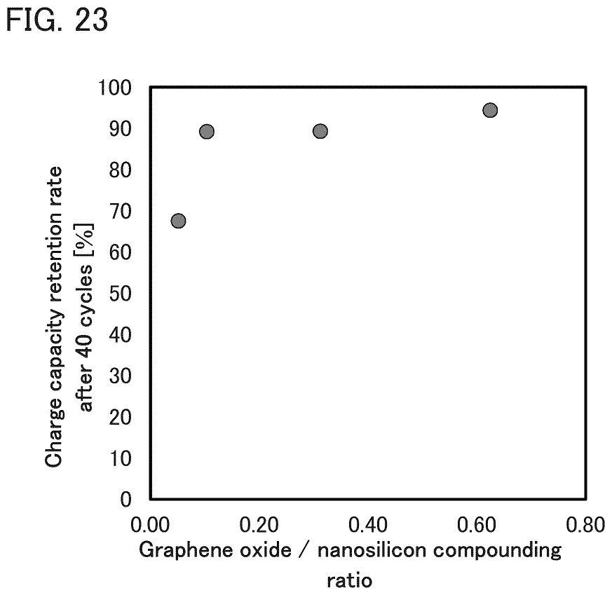

In FIG. 23, the GO/silicon ratio and the discharge capacity retention rate of the electrode GS1 to the electrode GS4 after 40 cycles are plotted as the electrode compounding ratio and the characteristics of the electrode GS1 to the electrode GS4. It is found that, as the electrode compounding ratio of graphene oxide and silicon in fabrication of the electrode, the ratio of the amount of graphene oxide with the amount of silicon being 1 is preferably greater than or equal to 0.05, further preferably greater than or equal to 0.10, still further preferably greater than or equal to 0.30. Note that the electrode compounding ratio shown in Table 2 is the weight ratio of the materials prepared in Steps S61, S72, and S80 in FIG. 4 in fabrication of the electrode GS1 to the electrode GS4.

### REFERENCE NUMERALS

300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 313: ring-shaped insulator, 322: spacer, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte, 509: exterior body, 510: positive electrode lead electrode, 511: negative electrode lead electrode, 570: electrode, 570a: negative electrode, 570b: positive electrode, 571: current collector, 571a: negative electrode current collector, 571b: positive electrode current collector, 572: active material layer, 572a: negative electrode active material layer, 572b: positive electrode active material layer, 576: electrolyte, 581: first particle, 582: second particle, 583: material with sheet-like shape, 584: electrolyte, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 700: power storage device, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1300: rectangular secondary battery, 1301a: battery, 1301b: battery, 1302: battery controller, 1303: motor controller, 1304: motor, 1305: gear, 1306: DCDC circuit, 1307: electric power steering, 1308: heater, 1309: defogger, 1310: DCDC circuit, 1311: battery, 1312: inverter, 1313: audio, 1314: power window, 1315: lamp, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: automobile, 2002: transporter, 2003: transport vehicle, 2004: airplane, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2300: unmanned aircraft, 2301: secondary battery, 2302: rotor, 2303: camera, 2603: vehicle, 2604: charge equipment, 2610: solar panel, 2611: wiring, 2612: power storage device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery

1. A lithium-ion secondary battery comprising a positive electrode, a negative electrode, an electrolyte solution, and a separator,
wherein the negative electrode comprises a first negative electrode active material comprising silicon and a second negative electrode active material comprising a graphite,
wherein the negative electrode further comprises graphene or graphene compound,
wherein the first negative electrode active material is in contact with the second negative electrode active material, and
wherein the graphene or the graphene compound is in contact with the first negative electrode active material and the second negative electrode active material.

2. A lithium-ion secondary battery comprising a positive electrode, a negative electrode, an electrolyte solution, and a separator,
wherein the negative electrode comprises a first negative electrode active material comprising a silicon compound and a second negative electrode active material comprising a graphite,
wherein the negative electrode further comprises graphene or graphene compound,
wherein the first negative electrode active material is in contact with the second negative electrode active material, and
wherein the graphene or the graphene compound is in contact with the first negative electrode active material and the second negative electrode active material.

3. A lithium-ion secondary battery comprising a positive electrode, a negative electrode, an electrolyte solution, and a separator,
wherein the negative electrode comprises a first negative electrode active material comprising silicon and a second negative electrode active material with a particle diameter of larger than the first active material,
wherein the negative electrode further comprises graphene or graphene compound,
wherein the first negative electrode active material is in contact with the second negative electrode active material, and
wherein the graphene or the graphene compound is in contact with the first negative electrode active material and the second negative electrode active material.

4. A lithium-ion secondary battery comprising a positive electrode, a negative electrode, an electrolyte solution, and a separator,
wherein the negative electrode comprises a first negative electrode active material comprising a silicon compound and a second negative electrode active material with a particle diameter of larger than the first active material,
wherein the negative electrode further comprises graphene or graphene compound,
wherein the first negative electrode active material is in contact with the second negative electrode active material, and
wherein the graphene or the graphene compound is in contact with the first negative electrode active material and the second negative electrode active material.

5. The lithium-ion secondary battery according to claim 1,
wherein the first negative electrode active material comprises amorphous silicon or polycrystalline silicon.

6. The lithium-ion secondary battery according to claim 3,
wherein the first negative electrode active material comprises amorphous silicon or polycrystalline silicon.

7. The lithium-ion secondary battery according to claim 2,
wherein the silicon compound is SiOₓ, and
wherein x is less than 2.

8. The lithium-ion secondary battery according to claim 4,
wherein the silicon compound is SiOₓ, and
wherein x is less than 2.

9. The lithium-ion secondary battery according to claim 2,
wherein the silicon compound comprises Li₂SiO₃ or Li₄SiO₄.

10. The lithium-ion secondary battery according to claim 4,
wherein the silicon compound comprises Li₂SiO₃ or Li₄SiO₄.

11. The lithium-ion secondary battery according to claim 1,
wherein a size of the second negative electrode active material is 10 times or more a size of the first negative electrode active material.

12. The lithium-ion secondary battery according to claim 2,
wherein a size of the second negative electrode active material is 10 times or more a size of the first negative electrode active material.

13. The lithium-ion secondary battery according to claim 3,
wherein a size of the second negative electrode active material is 10 times or more a size of the first negative electrode active material.

14. The lithium-ion secondary battery according to claim 4,
wherein a size of the second negative electrode active material is 10 times or more a size of the first negative electrode active material.

15. The lithium-ion secondary battery according to claim 1,
wherein a size of the first negative electrode active material is 50 nm or greater and 250 nm or less, and
wherein a size of the second negative electrode active material is 10 μm or greater and 20 μm or less.

16. The lithium-ion secondary battery according to claim 2,
wherein a size of the first negative electrode active material is 50 nm or greater and 250 nm or less, and
wherein a size of the second negative electrode active material is 10 μm or greater and 20 μm or less.

17. The lithium-ion secondary battery according to claim 3,
wherein a size of the first negative electrode active material is 50 nm or greater and 250 nm or less, and
wherein a size of the second negative electrode active material is 10 μm or greater and 20 μm or less.

18. The lithium-ion secondary battery according to claim 4,
wherein a size of the first negative electrode active material is 50 nm or greater and 250 nm or less, and
wherein a size of the second negative electrode active material is 10 μm or greater and 20 μm or less.

19. The lithium-ion secondary battery according to claim 1,
wherein the negative electrode comprises a negative electrode current collector, and
wherein the negative electrode current collector comprises copper.

20. The lithium-ion secondary battery according to claim 2,
wherein the negative electrode comprises a negative electrode current collector, and
wherein the negative electrode current collector comprises copper.

21. The lithium-ion secondary battery according to claim 3,
wherein the negative electrode comprises a negative electrode current collector, and
wherein the negative electrode current collector comprises copper.

22. The lithium-ion secondary battery according to claim 4,
wherein the negative electrode comprises a negative electrode current collector, and
wherein the negative electrode current collector comprises copper.

23. The lithium-ion secondary battery according to claim 1,
wherein the graphene or the graphene compound is in contact with the first negative electrode active material and the second negative electrode active material so as to cover, surround, or cling to the first negative electrode active material and the second negative electrode active material.

24. The lithium-ion secondary battery according to claim 2,
wherein the graphene or the graphene compound is in contact with the first negative electrode active material and the second negative electrode active material so as to cover, surround, or cling to the first negative electrode active material and the second negative electrode active material.

25. The lithium-ion secondary battery according to claim 3,
wherein the graphene or the graphene compound is in contact with the first negative electrode active material and the second negative electrode active material so as to cover, surround, or cling to the first negative electrode active material and the second negative electrode active material.

26. The lithium-ion secondary battery according to claim 4,
wherein the graphene or the graphene compound is in contact with the first negative electrode active material and the second negative electrode active material so as to cover, surround, or cling to the first negative electrode active material and the second negative electrode active material.

27. The lithium-ion secondary battery according to claim 1,
wherein a particle diameter of the second negative electrode active material is larger than a particle diameter of the first negative electrode active material.

28. The lithium-ion secondary battery according to claim 2,
wherein a particle diameter of the second negative electrode active material is larger than a particle diameter of the first negative electrode active material.
